(19) United States
(12) Patent Application Publication
(10) Pub. No.: US 2025/0236486 A1
(43) Pub. Date: Jul. 24, 2025

(54) DEVICE FOR COVERING A SURFACE COMPRISING A DRUM LONGITUDINAL TRANSLATION MECHANISM, PROVIDED WITH A CLUTCH SYSTEM

(71) Applicant: BECOFLEX, Strepy-Bracquegnies (BE)

(72) Inventor: Benoît Coenraets, Strepy-Bracquegnies (BE)

(73) Assignee: BECOFLEX, Strepy-Bracquegnies (BE)

(21) Appl. No.: 19/023,989

(22) Filed: Jan. 16, 2025

(30) Foreign Application Priority Data
Jan. 22, 2024 (BE) 20245035

(51) Int. Cl. B65H 75/44

(52) U.S. Cl. CPC B65H 75/4402; B65H 2403/72; B65H 2701/1922

(57) ABSTRACT

A device for covering a surface includes a cover (9), a drum mounted to rotate and able to wind or unwind the cover, and a translation system. The translation system includes a pair of closing spools (11r) mounted to rotate about a closing shaft (12) and each coupled to a closing cord (1c) to move the drum on rails (6) in a closing sense (Dc), and an axle shaft (12) coupled to the drum (2t) the rotation of which enables winding of the cover onto the drum (2t) and to move the cover on the rails in an opening sense (Do). A motor (M) connected to a driving shaft (10M) and coupled to a clutch system is configured to enable the driving shaft to actuate alternately rotation of the closing shaft (11) and the axle shaft (12).

### FIELD OF THE INVENTION

The invention relates to a device for covering a surface, which is easy to use and best responds to the demands of the application concerned. In particular, the present invention concerns a covering device in which the cover is wound around an axle of the drum forming with the latter a drum configured to be moved,
in a closing sense enabling deployment of the cover above the surface and activated by the winding of first and second closing cords around a closing axle by the rotation of the latter, and
in an opening sense enabling withdrawal of the cover from the surface and activated by the winding of the cover around the axle of the drum by the rotation of the latter.

The cover comprises a projecting bead enabling reversible locking of the longitudinal edges of the cover during its deployment. The covering device of the present invention is particularly simple and robust.

### TECHNOLOGICAL BACKGROUND

Covers are applied to surfaces for reasons that depend on the nature of those surfaces. Thus, in the case of a pool such as a swimming pool the cover can prevent pollution by leaves or animals, can save energy, water and reagents, and can or must ensure the safety of persons, in particular of children. In a pool for desalination or other treatments of a fluid, a cover makes it possible to prevent the dilution of a liquid due to rain or excessive evaporation due to heat.

In the case of sports grounds such as an outdoor clay or grass tennis court, a cover enables protection thereof against inclement weather, in particular intermittent rain. Furthermore, a vehicle body is covered in particular to ensure the stability of the load at the reduced pressure caused by the movement of the vehicle and to protect it against inclement weather. Covers are also used as blinds for greenhouses, winter gardens or vehicle windows in order to prevent overheating of the interior, and as solar protection for patio awnings.

In all these situations, what is generally sought is an economical covering device enabling easy, safe, reproducible and rapid covering and uncovering, necessitating minimum human intervention and, above all, having a service life that is as long as possible. Numerous devices for covering a surface have been developed, from basic models to the most sophisticated models. For example, a first entirely basic device used in the case of a swimming pool comprises a selectively inflatable cover that is unwound, extended and fixed manually to the edges of the swimming pool. This type of device is depicted for example in the documents U.S. Pat. No. 6,691,334, GB2379163 and FR2652373. It is clear that here, because of handling and storage, this concerns only swimming pools of relatively small size.

Many devices use a rotary drum to wind and store the cover when the surface is uncovered. Devices for covering a surface using a rotary drum can be classified in two categories.

Devices comprising a drum fixed at one of the transverse ends of the surface to be protected. The cover is deployed by traction, being unwound from the drum, and is driven along the surface as it is deployed and also it is retracted. This generates considerable friction that increases the force necessary for the deployment and the retraction of the cover, and accelerates the wear of the cover. Automatic covering devices are depicted in particular in the following documents: U.S. Pat. No. 3,574,979, GB2199741, US2005/0097834, CA2115113, US2001/0023506, U.S. Pat. No. 5,930,848, U.S. Pat. No. 400,190.

Devices in which the drum is mounted on a motorized or manual longitudinal translation mechanism. The latter moves the drum above the surface to be covered, which literally makes it possible to “place” the cover on the surface, as it is deployed, by simultaneously unwinding it from the drum during its longitudinal movement, and then to raise it, when it is retracted, by simultaneously winding it onto the drum. The cover therefore does not slide on the surface either during its deployment or during its retraction. Examples of automatic devices of this type are disclosed for example in the following documents: WO2005/026473, FR2900951, DE2257231, FR2893651, FR2789425, FR2743502, EP1719858, WO2023011789.

The present invention concerns devices (b) in which the drum is configured to be moved in longitudinal translation for the advantages that they offer compared to devices (a) comprising a fixed drum at one transverse edge of the surface.

In the present document the terms “longitudinal”, “transverse” and derivatives thereof respectively refer to the direction of movement of the drum, which is parallel to a longitudinal axis (X), and to the direction of the revolution axis of the drum, which is parallel to a transverse axis (Y). The terms “upstream” and “downstream” are defined according to the direction of translation of the drum, which is always indicated during their use.

In many applications it is advantageous to lock the longitudinal edges of the cover as it is deployed. This is particularly beneficial in the case of swimming pools, because it makes it possible to prevent persons present on the cover being thrown into the water through a gap between the longitudinal edge of the cover and the edge of the swimming pool. Furthermore, sealing the peripheral contact zone between the cover and the longitudinal edges of the surface can prevent introduction into the swimming pool of dirt, dead leaves and twigs as well as small animals such as mice or snakes. This also opens up the possibility of pressurizing the volume of air located between the surface of the water and the lower surface of the cover, in order to inflate the latter. More sophisticated devices have been proposed enabling reversible fixing of the longitudinal edges of the cover as it is deployed, such as in the document FR2803769, which provides a system for fixing the longitudinal edges of the cover consisting of sections of grids raised and then lowered section by section on said longitudinal edges of the cover with those edges being retained inside a channel as the cover is unwound. In this design, the longitudinal edges of the cover are clamped without being locked, which achieves a lower degree of safety, in particular in the case of swimming pools.

An advantageous system simultaneously enabling fixing of the longitudinal edges of the cover during its deployment and exerting a transverse traction force thereon to stretch it perfectly has been disclosed in WO2010/010152, WO2010054960 and in WO2014064138, WO2023170500 and WO2023011789. In these devices, the longitudinal edges of the cover are provided with a continuous bead or roll that is introduced into the upwardly oriented opening of a rail in the form of a U-section profiled member, with one or two fins partly closing said opening. The roll slides under a fin and is retained in this position by appropriate fixing means, enabling firm fixing of the longitudinal edges of the cover.

The system for moving the drum described in WO2010054960 comprises, on the one hand, a carriage comprising at each of its ends:
a driving wheel the rotation axis of which is parallel to that of the drum, which is preferably motorized,
at least two rollers resting on the rails and enabling longitudinal translation of the carriage, being mounted on respective opposite sides of the driving wheel, and constituting therewith a triangle of which the driving wheel forms the top apex, and, on the other hand,
   two flexible belts fixed only at each of their ends to the four corners of the surface to be covered, each of the two belts
being disposed in the opening of the rails in lateral sections between a fixing point and the roller nearest said fixing point, and
wrapping without sliding the driving wheel in the central section between the two rollers.

The rotation of the driving wheels that are attached without slipping to the flexible belts, which are fixed, drives the translation of the drum along the rails. The translation of the drum in the closing sense from a second width of the surface to which the cover is fixed to a first width of the surface also automatically causes the rotation of the drum that spontaneously unwinds the cover because of the force exerted on the cover by its end fixed to the second width of the surface. The rotation of the drum also enables stiffening of a torsion spring which reaches its point of maximum stiffness when the drum reaches the first width of the surface and the cover covers the surface completely. When the drum moves in the (opposite) opening sense, the torsion spring relaxes leading to driving of the rotation of the drum enabling winding of the cover around the axle of the drum.

This translation system gives excellent results and has been implemented in numerous embodiments, in particular for swimming pool covers. However, the stiffening of the torsion spring necessary for the rotation of the drum enabling winding in of the cover when the latter is withdrawn from the surface requires additional energy to be supplied to the motor driving the rotation of the driving wheel during the deployment of the cover when the drum moves in the closing sense. Furthermore, mounting the spring in the drum is difficult and cannot be done by an amateur. The weight of the device is also increased by this, which increases the delivery costs. It would nevertheless be desirable to reduce the number of parts and their weight, and also to reduce the complexity of assembly in order to reduce the price of the device and to enable a purchaser to take delivery themselves of the disassembled device in order to assemble it themselves or to have it assembled by workers who are not necessarily trained and qualified to assemble the device.

WO2023011789 proposes a simplified solution in which the translation system does not include torsion springs. The translation of the drum in the closing sense is effected by the rotation of the drum by a first motor, and the translation in the opening sense is effected by the rotation of spools rotationally fixed to the carriage and driven by a second motor, enabling winding in of a closing cord fixed at each corner of the first width of the surface and thus moving of the carriage. This translation system considerably reduces the number of parts of the device and above all enables the torsion spring to be omitted. However, when the first motor turns to wind the drum, it must compensate the high resistance of the second motor which does not freewheel, and vice versa. The first and second motors must therefore be uprated and their energy consumption consequently increases.

It would be beneficial to have a cover device with the same advantages as that described in WO2023011789, but without the additional forces caused by the motor under no load conditions and, preferably, using only a single motor for the translation of the drum. The present invention proposes a device of this kind, the simplicity of which enables persons who are not specifically qualified to assemble it. These advantages and other advantages are described in more detail in the following sections.

### SUMMARY OF THE INVENTION

The invention is as defined in the main claim, and preferred variants are defined in the dependent claims. The present invention concerns a device for covering a surface contained within a rectangle with first and second lengths extending parallel to a longitudinal axis (X) and first and second widths extending parallel to a transverse axis (Y), normal to the longitudinal axis (X). The device comprises a cover, two rails, a drum formed by the cover wound around an axle and mounted on a mechanism for longitudinal translation along the rails, and an insertion system for locking the edges of the cover in a groove in each of the rails.

The cover is substantially rectangular with dimensions equal to those of the rectangle. It comprises
first and second transverse edges opposite one another, the second transverse edge of the cover being fixed to the second width of the surface to be covered, and
first and second longitudinal edges opposite one another, each longitudinal edge being provided with a bead forming a projecting element, extending along each longitudinal edge.

The two rails are placed on respective opposite sides of said surface parallel to the longitudinal axis (X). Each rail consists of a profiled member having an opening on one of its faces oriented away from the surface to be covered and forming a groove extending all along each rail.

The drum comprising the axle which is mounted to rotate on first and second chassis at each of two ends of the axle. The axle supports the cover and is able to wind and to unwind the cover fixed to the axle by its first transverse edge. The drum is mounted on the longitudinal translation mechanism enabling longitudinal translation of the drum along the two rails
in an opening sense parallel to the longitudinal axis (X) enabling winding of the cover and its withdrawal from said surface, driven by the rotation of the axle about an axle shaft, and
in a closing sense parallel to the longitudinal axis (X) enabling unwinding of the cover and its deployment over the surface to be covered, driven by the rotation of first and second closing spools mounted to rotate about a closing shaft on the first and second chassis and coupled to first and second closing cords configured to drive the movement of the drum in the closing sense during the rotation of the first and second closing spools.

The insertion system is coupled, preferably rigidly coupled, to the chassis on each side of the surface to be covered. It is configured
to insert and to lock the bead of each longitudinal edge of the cover in the opening of the corresponding rail during the translation in the closing sense of the drum driving the unwinding of the cover, and
to unlock and to extract the bead on each longitudinal edge of the cover out of the opening of the corresponding rail during the translation in the opening sense of the drum driving the winding of the cover.

The invention is distinguished from the prior art, on the one hand, in that a single motor or crank is mounted on the first chassis and is configured to drive the rotation of a driving shaft and, on the other hand, in that the device comprises a clutch system configured so that the rotation of the driving shaft drives only the rotation of one of the closing shaft and the axle shaft at a time, passing between
a state engaged with the axle shaft so as to transmit a rotation movement of the driving shaft to the axle shaft to move the drum in the opening direction, and
a state engaged with the closing shaft so as to transmit a rotation movement of the driving shaft to the closing shaft to move the drum in the closing sense.

In a first variant, the clutch system comprises
a closing wheel configured to turn with the closing shaft,
an axle wheel configured to turn with the axle shaft,
a drive system comprising first and second driving wheels mounted coaxially and rigidly on the driving shaft and configured to turn with the driving shaft,
a closing belt forming a closed loop connecting the first driving wheel to the closing wheel, and
an axle belt forming a closed loop connecting the second driving wheel to the axle wheel.

This clutch system operates in the following manner:
in the state engaged with the closing shaft, the closing belt is at least partly tensioned, so that the rotation of the first driving wheel drives the rotation of the closing wheel, while the axle belt is relaxed,
in the state engaged with the axle shaft, the axle belt is at least partly tensioned, so that the rotation of the second driving wheel drives the rotation of the axle wheel, while the closing belt is relaxed.

In a first embodiment of the first variant defined hereinabove, the driving shaft, the closing shaft and the axle shaft are at fixed positions relative to one another and separated from one another so that the closing and axle belts are both relaxed. The clutch system comprises
a closing roller pressing the closing belt against the closing wheel,
an axle roller pressing the axle belt against the axle wheel,
a closing engagement roller and an axle engagement roller mounted on a structure.

The structure supporting the closing and axle rollers is configured to move the closing engagement roller and the axle engagement roller between the state engaged with the closing shaft and the state engaged with the axle shaft, in the following manner:
in the state engaged with the closing shaft, the closing engagement roller is moved, preferably by rotation of the structure, until it presses the closing belt against the first driving wheel, while the axle engagement roller applies no or less pressure to the axle belt, and
in the state engaged with the axle shaft, the axle engagement roller is moved, preferably by rotation of the structure, until it presses the axle belt against the second driving wheel, while the closing engagement roller applies no or less pressure to the closing belt.

In a second embodiment of the first variant defined hereinabove, the driving shaft is configured to be moved to vary a first distance separating it from the closing shaft between a first engagement distance and a first disengagement distance, and simultaneously to vary a second distance separating it from the axle shaft between a second disengagement distance and a second engagement distance, respectively. The movement of the driving shaft thus enables
either turning of only the axle wheel and the axle shaft, in order to move the drum in the opening sense, with the first disengagement distance and the second engagement distance,
or turning of only the closing wheel and the closing shaft, in order to move the drum in the closing sense, with the first engagement distance and the second disengagement distance.

In a third embodiment of the first variant defined hereinabove, the driving shaft, the closing shaft and the axle shaft are at fixed positions relative to one another and separated from one another so that the closing and axle belts are both relaxed. An engagement roller is connected to a shaft parallel to the driving shaft, the closing shaft and the axle shaft, the shaft being movable between
a first engagement position in which the engagement roller presses on the closing belt to tension it between the first driving wheel and the closing wheel thereby defining the state engaged with the closing shaft, and
a second engagement position in which the engagement roller presses on the axle belt to tension it between the second driving wheel and the axle wheel thereby defining the state engaged with the axle shaft.

In a second variant of the invention, the clutch system does not comprise closing and axle belts. The clutch system comprises
a closing wheel configured to turn with the closing shaft,
an axle wheel configured to turn with the axle shaft, and
a drive system comprising first and second driving wheels mounted coaxially and rigidly on the driving shaft and configured to turn with the driving shaft.

The driving shaft is configured to be moved between
a closing position in which the first driving wheel is in rubbing contact with the closing wheel defining the state engaged with the closing shaft, and
an axle position in which the second driving wheel is in rubbing contact with the axle wheel defining the state engaged with the axial shaft.

In a third variant of the invention, the clutch system does not comprise closing and axle belts. The clutch system comprises
a closing wheel configured to turn with the closing shaft,
an axle wheel configured to turn with the axle shaft, and
a drive system comprising first and second driving wheels mounted coaxially and rigidly on the driving shaft and configured to turn with the driving shaft.

The driving shaft, the closing shaft and the axial shaft are at fixed positions relative to one another and separated from one another so that the first and second driving, closing and axle wheels do not touch. The device further comprises an engagement roller connected to a shaft parallel to the driving, closing and axle shafts, the shaft being movable between
a position in contact with the closing wheel in which the engagement roller is in rubbing contact with the first driving wheel and the closing wheel thereby defining the state of engagement with the closing shaft, and
a position in contact with the axle in which the engagement roller is in rubbing contact with the second driving wheel and the axle wheel thereby defining the state of engagement with the axle shaft.

In a preferred embodiment of the second and/or third variant(s) (=not comprising closing and axle belts), the first and second driving wheels, the closing wheel and the axle wheel are toothed wheels or have adherent, preferably structured, rim surfaces, enabling transmission of rotation from one wheel to the other without slipping when they are in rubbing contact.

In order to control the free rotation of the shaft that is not engaged, the clutch system can be configured to brake its free rotation in a controlled manner in one of the following ways:
a braking element is configured to apply a friction force to the closing shaft or the closing wheel or the axle wheel that is not driven in rotation by the drive system, the braking element is preferably resilient and the braking element is further preferably mobile according to the state of engagement of the clutch system, applying a friction force only to the shaft or the wheel that is not driven in rotation by the drive system, or
in a device according to the first variant (with belts), the closing belt or the axle belt that is relaxed applies a friction force to the corresponding closing wheel or axle wheel that it surrounds, sufficient to brake the free rotation of the corresponding shaft.

In one form of the device, the groove in each rail is partly closed by a flange. The device comprises at each rail a locking belt which is fixed to each end of the rail, housed in the groove between each end and the corresponding chassis, and exits the groove at the level of the corresponding chassis by the action of idler pulleys. The idler pulleys are configured to insert the locking belt in the groove downstream of the insertion system in order to wedge the bead under the flange leaving only an open space in the opening that is insufficient to allow the bead to exit the groove via the opening, wherein the term downstream is defined relative to the closing sense.

In one particularly preferred embodiment of this form of the device, the locking belts are formed by the closing cords, which wrap without slipping the corresponding closing wheels. The closing belts therefore combine the functions of movement of the drum in the closing sense and of locking/unlocking the longitudinal edges of the cover in the grooves of the rails.

In an alternative form of the device, the opening of each rail gives access to a space in the rail with dimensions along the transverse axis greater than those of the opening. In a cross section normal to the longitudinal axis (X), the opening of the groove has a maximum width (Lo) and the space has a maximum width greater than the maximum width (Lo) of the opening (Lo<Le), with the maximum widths (Lo, Le) measured parallel to the transverse axis (Y).

In a section normal to each longitudinal edge of the cover, the corresponding bead defines an elongate geometry defined by a ratio (D\d) of a first diameter (D) to a second diameter (d) greater than unity (i.e. D/d>1), preferably the ratio D/d>1.3, more preferably D/d>1.5. The first diameter (D) is defined as the length of the straight line linking the two points the farthest apart from one another of the perimeter of the geometry and the second diameter (d) is the length of the longest straight line perpendicular to the first diameter (D) that connects two points of the perimeter.

The insertion system is configured to orient the bead through the opening in the corresponding rail by having a diameter between d and D and less than Lo, the bead changing orientation once the bead is located in the space so that once inserted in the space, the bead alone occupying the space cannot escape from it only because of the action of a force (F) applied parallel to the transverse axis (Y) in the direction of the surface to be covered.

In one embodiment of the device, the second chassis comprises no motor and the closing shaft of the first chassis extends parallel to the transverse axis (Y) as far as the closing spool of the second chassis so that the rotation of the closing spool of the first chassis drives the synchronous rotation of the closing spool of the second chassis.

In a second embodiment, more suitable for large surfaces, the second chassis comprises a single second motor configured to cause the driving shaft to turn and the device comprises a clutch system identical to that of the first chassis, configured so that the second motor drives the rotation of only the closing shaft or the axle shaft at a time.

The motor or the crank preferably turns the same way in the opening direction (Do) and the closing direction (Dc). This enables use of less costly motors and prevents rotation of the crank in the wrong sense.

The present invention also concerns use of the device according to the present invention to cover a surface selected from:
(a) a pool filled with a liquid or empty, the pool being chosen from a swimming pool, jacuzzi, retention pool, water treatment or water desalination pool;
(b) a sports ground, such as a tennis court or cricket pitch;
(c) a vehicle body;
(d) a glazed surface such as a greenhouse, a winter garden or a vehicle window.

### BRIEF DESCRIPTION OF THE FIGURES

The above aspects and other aspects of the invention will become clearer in the detailed description of particular embodiments of the invention, with reference being made4to the drawings of the figures, in which:

FIGS. 1a and 1b are overall views of two examples of the device in accordance with the invention for covering a surface formed by a swimming pool.

FIGS. 2a and 2b are views of a variant of the clutch system of the present invention (a) in translation position in the opening sense (=rotation of the drum) and (b) in translation position in the closing sense (=rotation of the closing wheel).

FIGS. 3a and 3b are views of an alternative variant of the clutch system of the present invention (a) in translation position in the opening sense (=rotation of the drum) and (b) in translation position in the closing sense (=rotation of the closing wheel).

FIGS. 4a and 4b are views of an alternative variant of the clutch system of the present invention (a) in translation position in the opening sense (=rotation of the drum) and (b) in translation position in the closing sense (=rotation of the closing wheel).

FIGS. 5a and 5b are views of an alternative variant of the clutch system of the present invention (a) in translation position in the opening sense (=rotation of the drum) and (b) in translation position in the closing sense (=rotation of the closing wheel).

FIGS. 6a and 6b are views of an alternative variant of the clutch system of the present invention (a) in translation position in the opening sense (=rotation of the drum) and (b) in translation position in the closing sense (=rotation of the closing wheel).

FIGS. 7a and 7b are views of an alternative variant of the clutch system of the present invention (a) in translation position in the opening sense (=rotation of the drum) and (b) in translation position in the closing sense (=rotation of the closing wheel).

FIGS. 8a and 8b are views of an example of the chassis of the device in accordance with the invention (a) as seen from the surface to be covered and (b) as seen from the clutch system.

FIG. 9a Shows an example front view of a belt of a clutch system enveloping the first or second driving wheel of a drive system or the closing wheel or axle wheel.

FIG. 9b Shows an example in cross section of the closing and axle belts enveloping the first and second driving wheels of a drive system.

FIG. 9c Shows an example in cross section of a closing or axle belt enveloping the corresponding closing or axle wheel.

FIGS. 10a and 10b are views as if by transparency of the functioning of a variant clutch system as seen in the translation direction of the carriage, with (a) the clutch in a closing position and driving the rotation of the closing wheel and (b) the clutch in an opening position and driving the rotation of the drum.

FIGS. 10c and 10d are views of a clutch system comprising a brake mechanically coupled to the lever enabling application to the shaft when freewheeling of a pressure depending on the position of the lever.

FIGS. 11a to 11d are views of a variant of the system for inserting and locking the bead in the groove of the rail showing: (a) a cross section of the bead moved over the opening, (b) a cross section of the bead oriented to enable it to penetrate through the opening, (c) locking of the bead in the space of the groove, and (d) a perspective view of the bead locked in the groove.

FIGS. 12a to 12d are views of a variant of the system for inserting and locking the bead in the groove of the rail showing: (a) cross section of the bead moved over the opening, (b) a cross section of the bead oriented to enable it to penetrate through the opening, (c) locking of the bead in the space of the groove by insertion of the closing cord in the groove, and (d) a perspective view of the bead locked in the groove by the closing cord.

FIGS. 13a to 13c are a front view and a view in section of a first example of a preferred variant clutch system in accordance with the invention in (a) a neutral configuration, (b) a configuration for engaging the axle shaft, and (c) a configuration engaged with the closing shaft.

FIG. 13d is a perspective view of the example clutch system from FIGS. 13a to 13c.

FIGS. 14a to 14c are front views of a second example of the preferred variant of the clutch system the first example of which is represented in FIGS. 13a to 13d in (a) a neutral configuration, (b) a configuration for engaging the axle shaft, and (c) a configuration engaged with the closing shaft.

FIGS. 15a to 15c are front views of a third example of the preferred variant of the clutch system the first and second examples of which are represented in FIGS. 13a to 13d and 14a to 14c in (a) a neutral configuration, (b) a configuration for engaging the axle shaft, and (c) a configuration engaged with the closing shaft.

FIGS. 16a to 16c show an alternative variant of the system for translation of the drum and insertion and locking of the bead in the groove of the rail with the aid of the closing cord in: (a) a perspective view of the closing belt at the level of the chassis, (b) a cross section of the rail downstream of the chassis, with the bead of the cover locked under the flange of the groove by the closing cord, and (c) cross section of the rail upstream of the chassis, with the closing cord inserted in the groove; the terms “upstream” and “downstream” being defined with reference to the closing translation sense.

FIGS. 17a to 17c show an alternative variant of the system for translation of the drum and insertion and locking of the bead in the groove of the rail with the aid of a locking belt in: (a) a perspective view of the locking belt at the level of the chassis, (b) a cross section of the rail downstream of the chassis, with the bead of the cover locked under the flange of the groove by the locking cord, and (c) a cross section of the rail upstream of the chassis, with the closing cord and the locking belt inserted in the groove, the terms “upstream” and “downstream” being defined with reference to the closing translation sense.

### DETAILED DESCRIPTION OF THE INVENTION

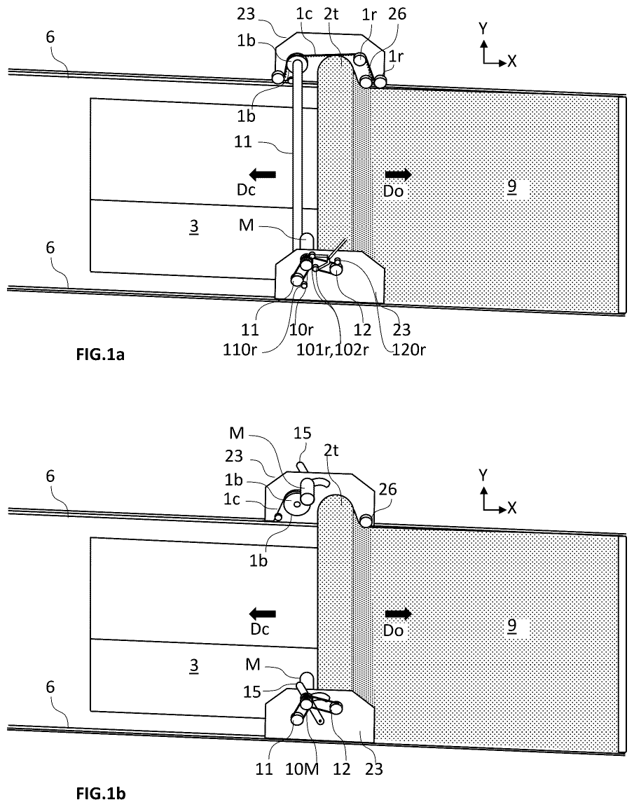

As represented in FIGS. 1a and 1b, the (automatic) device in accordance with the invention for covering a surface (3) comprises a cover (9) intended to protect said surface (3). The surface (3) is contained within a rectangle with first and second lengths extending parallel to a longitudinal axis (X) and first and second widths extending parallel to a transverse axis (Y), normal to the longitudinal axis (X) and defining therewith a plane (X, Y). The device enables covering in particular of the surfaces defined by the contour of a pool of water such as a swimming pool, water treatment pool, waste water purification station, retention pool, desalination station, etc. Nevertheless, the invention could be used in any field necessitating the covering of a surface, such as for example a sports ground, such as a clay or grass tennis court, a vehicle body, a glazed surface, for example of a greenhouse, a window of a vehicle such as a train or a bus, or a winter garden, or an opening in a wall or ceiling, etc. Generally speaking, what is therefore meant by “surface” in the present application is any zone delimited by a substantially rectangular perimeter.

The device comprises a cover (9), two rails (6), a drum (2t), a system for inserting and locking the cover in the rails, and a clutch system enabling a motor to be connected alternately to the drum and to a closing spool (1b) enabling translation of the drum in the opening direction (Do) and the closing direction (Dc).

The cover (9) is substantially rectangular with dimensions equal to those of the rectangle. The cover (9) has, on the one hand,
first and second transverse edges opposite one another, the second transverse edge of the cover being fixed to the second width of the surface to be covered, and, on the other hand,
first and second longitudinal edges opposite one another, each longitudinal edge being provided with a bead (9j) forming a projecting element extending along each longitudinal edge.

As depicted in FIGS. 1a and 1b, the two rails (6) are placed on respective opposite sides of said surface (3) and parallel to the longitudinal axis (X). Each rail consists of a profiled member having an opening (14) on one of its faces and oriented away from the surface to be covered, forming a groove extending all along each rail.

The drum (2t) comprises an axle (2e) mounted to rotate on first and second chassis (23) at each of the two ends of the axle. The drum supports the cover (9) and is adapted to wind and unwind the cover (9) fixed to the axle by its first transverse edge. The drum (2t) is mounted on a longitudinal translation mechanism enabling longitudinal translation of the drum along the two rails in an opening sense (Do) and in a closing sense (Dc).

The opening sense (Do) of translation of the drum (2t) is parallel to the longitudinal axis (X) and enables winding of the cover and its removal from said surface (3). The rotation of the drum (2t) is driven by the rotation of a motor (M) and/or of a crank causing an axle shaft (12) and the axle (2e) to turn.

The closing sense (Dc) is also parallel to the longitudinal axis (X) and enables unwinding of the cover and its deployment over the surface (3) to be covered. The translation of the drum in the closing sense (Dc) is driven by the rotation of the same motor (M) or of the same crank as for the opening sense (Do) by causing to turn a closing shaft (11) and first and second closing spools (1b) mounted to rotate on the first and second chassis (23) and enabling winding around closing spools (1b) of first and second closing cords (1c) each having one end fixed to the first width of the surface to be covered.

The insertion system (26) is coupled, preferably rigidly coupled, to the chassis on each side of the surface to be covered and is configured, on the one hand,
to insert and to lock the bead (9j) in the groove of each rail during translation in the closing sense (Dc) of the drum driving the unwinding of the cover, and, on the other hand,
to unlock and to remove the bead (9j) from the groove during translation in the opening sense (Do) of the drum driving the winding of the cover.

The device comprises only one motor (M) or crank mounted on the first chassis (23) (and optionally only one motor (M) or crank mounted on the second chassis (23)). The motor (M) of the first chassis (and, optionally, of the second chassis) is configured to cause a driving shaft (10M) to turn. The invention is distinguished from the prior art in that the device comprises a clutch system configured so that the motor (M) or crank drives the rotation of only the closing shaft (11) or the axle shaft (12) at a time, passing between,
on the one hand, a state of engagement with the axle shaft (12) so as to transmit a rotation movement of the driving shaft (10M) to the axle shaft (12) to move the drum (2t) in the opening sense (Do), and,
on the other hand, a state of engagement with the closing shaft (11) so as to transmit a rotation movement of the driving shaft (10M) to the closing shaft (11) to move the drum (2t) in the closing sense (Dc).

In the state engaged with the axle shaft (12), the closing shaft (11) is not driven by the motor (M) to move the drum in the closing sense (Dc). Conversely, in the state engaged with the closing shaft (11), the axle shaft (12) is not driven by the motor (M) to move the drum in the opening sense (Do).

### Drum Longitudinal Translation Mechanism

The second end of the cover (9) is fixed to the second width of the surface to be covered. The person skilled in the art knows different ways to fix an end of a cover to a width of a surface and the present invention is not restricted by the choice of one solution or another known in the art. The first end of the cover is fixed to the axle (2e) and the cover is partly or entirely wound around the axle depending on the position of the axle relative to the second width. The drum (2t) is formed of the axle (2e) with the cover (9) wound around the axle. The axle (2e) is mounted to be rotated on the first and second chassis by an axle shaft (12). The rotation of the drum in the sense of winding the cover applies a tension to the cover portion deployed over the surface and therefore drives the translation of the drum in the opening sense (Do) in the direction of the second width. The rotation of the drum in the other sense unwinds the cover located on the axle, but does not enable movement of the drum (2t).

A different mechanism is therefore necessary for driving the movement of the drum in the closing sense (Dc). Two closing cords (1c) are used.

Closing System with Fixed Closing Cords (1c)

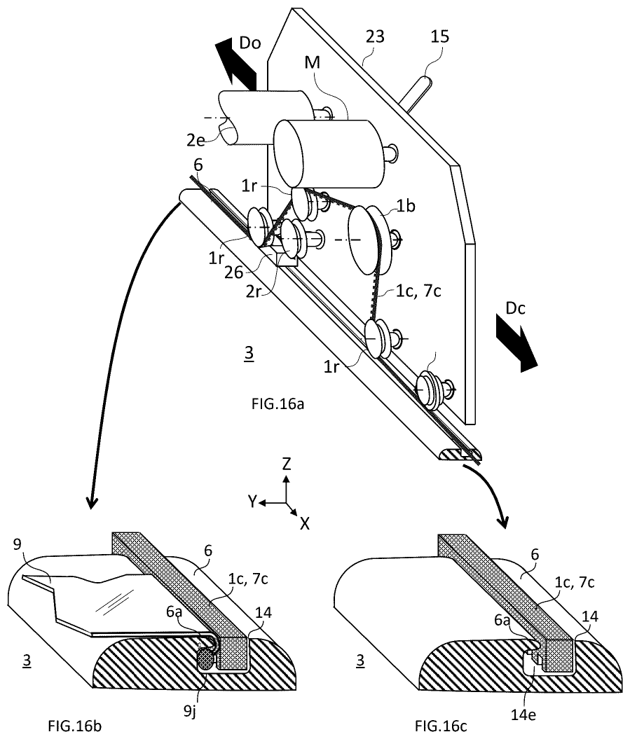

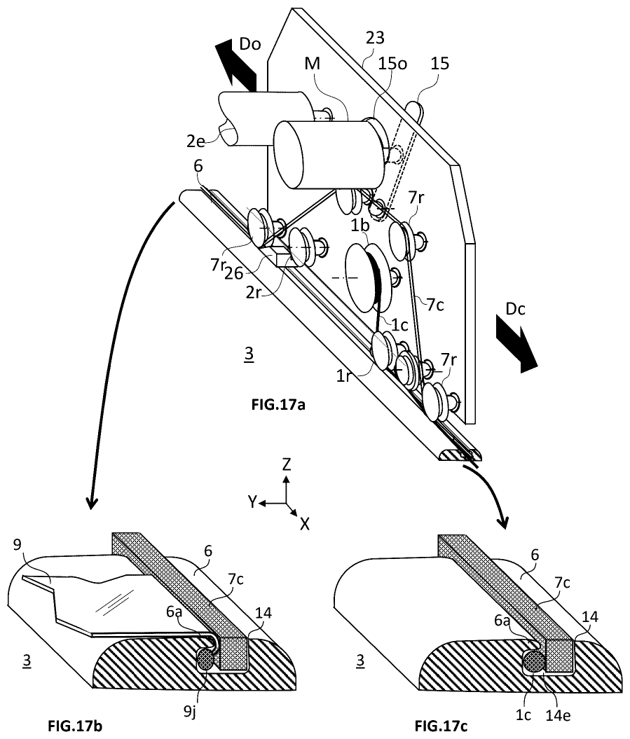

In a first variant of the invention depicted in FIGS. 1a and 16a, each closing cord (1c) extends along each rail and the two ends of each closing cord (1c) are fixed to a corner of the surface, preferably at the ends of each rail (6). Each closing cord (1c) extends along each rail, preferably inserted in the groove of the corresponding rail (6) upstream and downstream of the drum (2t). An idler pulley (1r) positioned at one end of the corresponding chassis (23) removes the closing cord (1c) from the groove and guides it toward a closing spool (1b) rotationally fixed to each of the first and second chassis (23) and configured to turn with the closing shaft (11). The closing cord (1c) caps the circumference of the closing spool over a sufficient distance to prevent any slipping of the closing cord on the closing spool during the rotation of the latter. As depicted in FIGS. 16a to 16c, the closing cord (1c) is preferably notched and the rim of the closing spool is preferably also notched in order to form a rack system. Alternatively, the closing cord (1c) and the rim of the closing spool have a structured surface increasing the friction forces between the two and preventing slipping of one relative to the other. The closing cord (1c) therefore includes a portion that leaves the groove of the rails (6) and caps the closing spool (1b) at the level of the chassis, forming a wave or ripple that moves with the chassis (23).

A similar—although different—translation system is described in WO2010054960, with the difference that the motor or crank is not adapted specifically to activate the rotation of the axle shaft and that it is therefore necessary to install a torsion spring in the axle (2e) to activate the rotation of the axle shaft during movement of the drum in the opening sense (Do) in order to gather the cover. The present invention makes it possible to omit the torsion spring by specifically activating the rotation of the axle shaft (2e) when the clutch system is in the state engaged with the axle shaft (12).

Therefore, the drum (2t) can thus be moved in both the closing sense (Dc) and the opening sense (Do) in the following manner. In the closing sense (Dc), the clutch system is in the state engaged with the closing shaft (11). The rotation of the closing shaft (11) driven by the motor (M) or crank drives the rotation of the closing wheels that “roll” (without slipping) along the corresponding closing cords (1c). In the opening sense (Do), the clutch system is in the state engaged with the axle shaft (12). The rotation of the axle shaft driven by the motor (M) or crank drives the winding of the cover (9). The traction on the cover portion (9) covering the surface pulls the drum (2t) toward the second width in the opening sense (Do). The closing spool (1b) is able to turn freely as it “rolls” along the closing cord (1c).

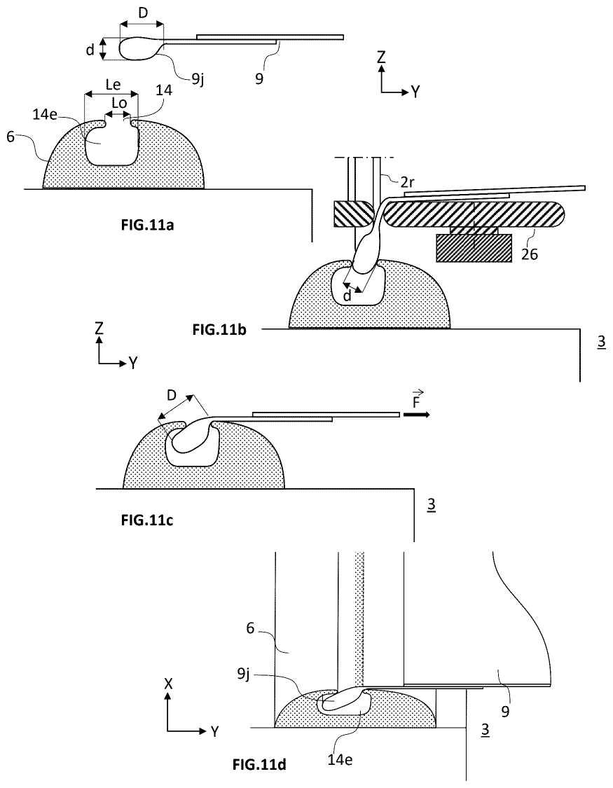

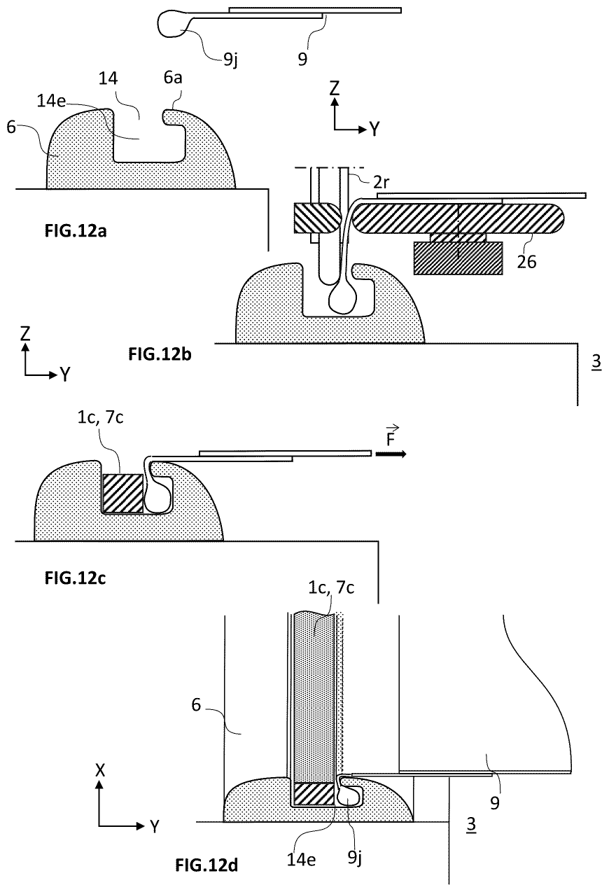

This variant of the translation system of the present invention is advantageous because it combines the functions of translation of the drum (2t) and of locking of the bead (9j) in the space (14e) of the groove of the corresponding rail as depicted in FIGS. 12a to 12d. The locking force obtained by this means is greater than that which can be obtained with only locking of the bead (9j), as depicted in FIGS. 11a to 11d. As shown in FIGS. 12a to 12d and 16a to 16c, during the movement of the drum in the closing sense (Dc), the closing cord (1c) is inserted in the groove downstream of the insertion system (2r, 26) that inserts the bead (9j) in the groove, thus obstructing the opening (14) and wedging the bead (9j) in the space (14e) under the flange (6a), with no possibility of the bead (9j) escaping without first withdrawing the closing cord (1c). The locking force obtained in this way is very high.

Another advantage of this variant is that the closing spool (1b), being wrapped by the closing cord (1c), is not able to turn freely when the clutch system is in the state engaged with the axle shaft (12). A braking system (19), discussed hereinafter, is therefore not necessary for the closing spool (1b).

Closing System with Winding of Closing Cords (1c)

In a second variant of the invention depicted in FIGS. 1b, 8a, 10a, 10b and 17a, each closing cord (1c) is fixed to a corner of the first width of the surface (that is to say the width opposite the second width to which one end of the cover is fixed), preferably at the end of each rail (6). The other end of each closing cord (1c) is fixed to the closing spool (1b) rotationally fixed to each of the first and second chassis (23). The closing wheels are fixed to a closing shaft (11) parallel to the transverse axis (Y). The rotation of the closing wheels driving the winding of each closing cord (1c) applies tension to the closing cord portion between the closing spool (1b) and the end of the corresponding cord fixed to the first width, thereby driving the translation of the drum in the closing sense (Dc) in the direction of the first width of the surface (3). This translation movement automatically drives the unwinding of the cover (9) from the drum. It is therefore not necessary to activate the rotation of the axle shaft (12) when the drum moves in the closing sense (Dc). Similarly, when the drum moves in the opening sense (Do), the closing cords (1c) unwind spontaneously from the closing spools (1b). It is therefore not necessary to activate the rotation of the closing shaft (11) when the drum moves in the opening sense (Do).

It therefore suffices to drive the rotation of the closing shaft (11) to move the drum in the closing sense (Dc) and to cover the surface (3) with the cover (9). To remove the cover (9) from the surface (3) it suffices to drive the rotation of the axle shaft (12). In WO2023011789, it is proposed to activate the rotation of the closing shaft (11) by a first motor and the axle shaft by a second motor. As discussed hereinabove, when one of the two motors is activated, the other motor, which is not activated, offers a substantial resistance because it does not freewheel. This obliges the activated motor to apply a greater force and in many cases requires uprating of the motors.

The present invention proposes to use a clutch system enabling a single motor to activate the rotation of only the closing shaft (11) or the axle shaft (12) at a time. Apart from avoiding the purchase and installation of a second motor, this solution has the advantage that the motor does not have to compensate the resistance to rotation of a second motor, thus enabling the motor to be rated according to the dimensions of the device alone, without uprating it to compensate the presence of the second motor.

### Clutch System

The clutch system of the present invention enables a single motor (M) or crank (not depicted) to activate the rotation of only the closing shaft (11) or the axle shaft (12) at a time. The clutch system is configured to pass alternately between a state engaged with the axle shaft (12) and a state engaged with the closing shaft (11). In the state engaged with the axle shaft (12), the rotation movement of the driving shaft (10M) drives a rotation movement of the axle shaft (12) to move the drum (2t) in the opening sense (Do). In the state engaged with the closing shaft (11), the rotation movement of the driving shaft (10M) drives a rotation movement of the closing shaft (11) to move the drum (2t) in the closing sense (Dc). A number of variant clutch systems are envisaged. The clutch system can for example comprise one or more of the following elements:
a belt (11c, 12c) connecting the driving shaft (10M) to the closing shaft (11) and the axle shaft (12),
a closing engagement roller (101r) and an axle engagement roller (102r) that are mobile and configured to apply alternately a pressure to the closing belt (11c) and the axle belt (12c) against the closing wheel (11r) and the axle wheel (12r), respectively,
a system for moving the driving shaft closer to the closing shaft (11) or the axle shaft (12) and away from the other of those shafts,
a mobile engagement roller (13r) enabling mechanical contact between the driving shaft (10M) and the closing shaft (11) and the axle shaft (12) to be established alternately.

In a preferred variant, the motor (M) or the crank always turns in the same sense whether that is to actuate the translation of the drum (2t) in the opening sense (Do) or the closing sense (Dc). For this it suffices to wind the closing cords (1c) in the corresponding sense around the closing spool (1b) and the cover (9) around the axle (2e), with the aid of idler pulleys (1r, 2r) positioned appropriately. It is of course possible to cause the motor (M) or the crank to turn in different rotation directions according to whether the drum is moved in the closing sense (Dc) or the opening sense (Do) by reversing the direction of winding of the cover (9) or the closing cords (1c) around the axle (2e) or the closing spool (1b), respectively.

Clutch System with Belts (11c, 12c)

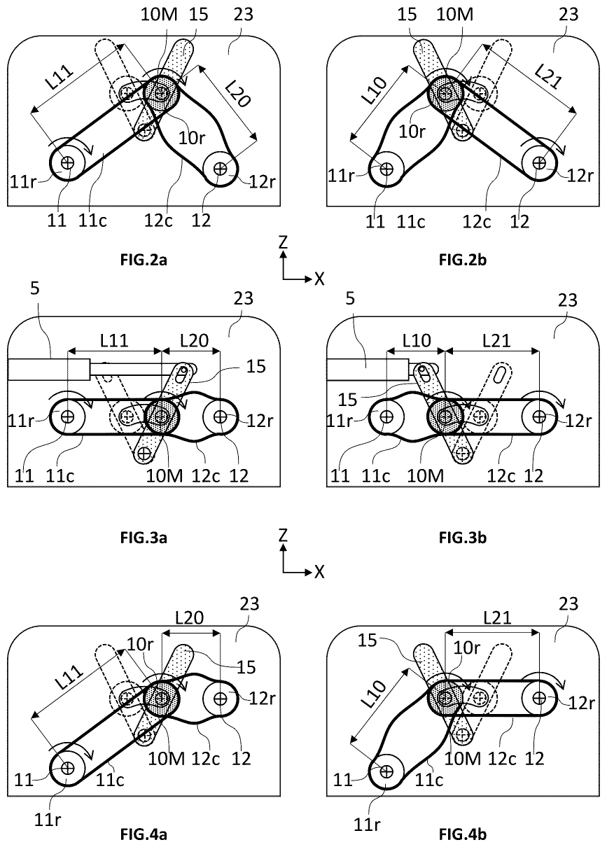

In a variant of the invention, depicted in FIGS. 2 to 5, 8b, 9 and 10, the clutch system comprises
a closing wheel (11r) configured to turn with the closing shaft (11), an axle wheel (12r) configured to turn with the axle shaft (12) and a drive system (10r) comprising first and second driving wheels (10M1, 10M2) coaxial with and configured to turn with the driving shaft (10M),
a closing belt (11c) forming a closed loop connecting the first driving wheel (10M1) to the closing wheel (11r) and an axle belt (12c) forming a closed loop connecting the second driving wheel (10M2) to the axle wheel (12).

In the state engaged with the closing shaft (11) (i.e., to move the drum in the closing sense (Dc)), the closing belt (11c) is, depending on the variant, partially or entirely under tension, so that the rotation of the first driving wheel (10M1) drives the rotation of the closing wheel (11r), whereas the axle belt (12c) is not under tension and does not transmit the rotation movement of the second driving wheel (10M2) to the axle shaft (12). Conversely, in the state engaged with the axle shaft (12) (i.e., to move the drum in the opening sense (Do)), the axle belt (12c) is, depending on the variant, partially or entirely under tension, so that the rotation of the second driving wheel (10M2) drives the rotation of the axle wheel (12r), whereas the closing belt (11c) is not under tension and does not transmit the rotation movement of the first driving wheel (10M1) to the closing shaft (11).

The use of belts (11c, 12c) to transmit the rotation movement of the driving shaft (10M) alternately to the closing shaft (11) and the axle shaft (12) is advantageous in that it allows great freedom in the positioning of the various shafts (10M, 11, 12) on the first chassis (23). FIGS. 2a and 2b to 4a and 4b show three examples of different positions of the closing shaft (11) and the axle shaft (12) relative to the position of the driving shaft (10M).

Clutch System with Belts (11c, 12c) with Mobile Closing Engagement Roller (101r) and Axle Engagement Roller (102r)

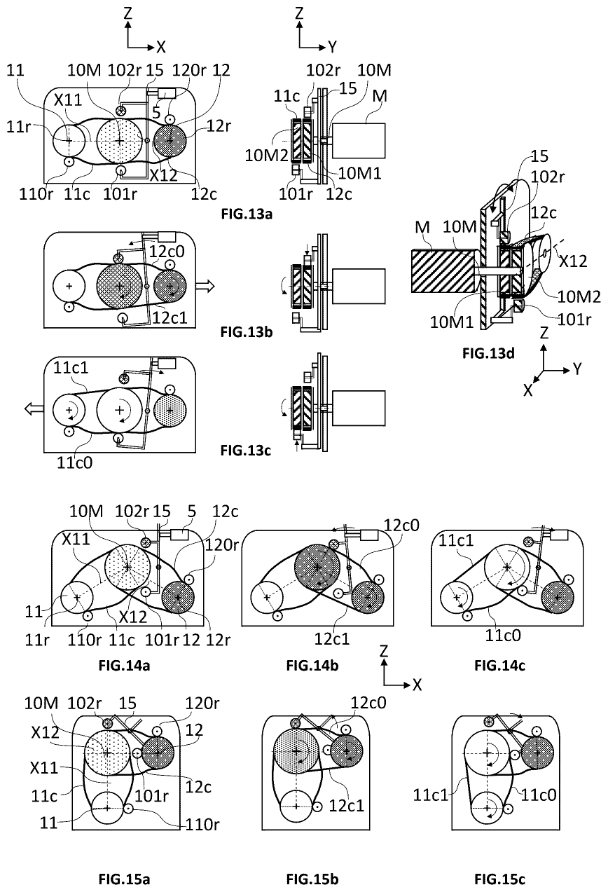

In a first variant with belts (11c, 12c), depicted in FIGS. 13a to 13d, 14a to 14c and 15a to 15c, the clutch system comprises
a closing roller (110r) pressing the closing belt (11c) against the closing wheel (11r),
an axle roller (120r) pressing the axle belt (12c) against the axle wheel (12r), and
a closing engagement roller (101r) and an axle engagement roller (102r) mounted on a structure configured to move the closing engagement roller (101r) and the axle engagement roller (102r) between the state engaged with the closing shaft (11) and the state engaged with the axle shaft (12), as explained below.

In this first variant, the driving shaft (10M), the closing shaft (11) and the axle shaft (12) are at positions fixed relative to the first chassis (23). The closing belt (11c) and the axle belt (12c) have a length configured to wrap with little or no friction the first driving wheel (10M1) to the closing wheel (11r) and the second driving wheel (10M2) to the axle wheel (12r), so that neither is under tension. The closing belt (11c) is nevertheless clamped between the rim of the closing wheel (11r) and the closing roller (110r) that is rotatably mounted on the first chassis (23) at a position defined below. Similarly, the axle belt (12c) is clamped between the rim of the axle wheel (12r) and the axle roller (120r) that is also rotatably mounted on the first chassis (23) at a position defined below.

The closing engagement roller (101r) and the axle engagement roller (102r) are preferably mounted on a rigid structure, rotatably mounted on the first chassis (23) so that the rotation of the rigid structure enables simultaneous movement of the closing engagement roller (101r) and the axle engagement roller (102r) between
a position defining the state engaged with the closing shaft (11) depicted in FIGS. 13c to 15c, in which the closing belt (11c) is clamped between the rim of the first driving wheel (10M1) and the closing engagement roller (101r), whereas the axle engagement roller (102r) does not contact (or contacts with little force) the axle belt (12c), and
a position defining the state engaged with the axle shaft (12) depicted in FIGS. 13b to 15b, in which the axle belt (12c) is clamped between the rim of the second driving wheel (10M2) and the axle engagement roller (102r), whereas the closing engagement roller (101r) does not contact (or contacts with little force) the closing belt (11c).

FIGS. 13a to 15a depict the position of the structure defining a stand-by state, in which neither the closing engagement roller (101r) nor the axle engagement roller (102r) contacts the closing belt (11c) and axle belt (12c) (or else contact these with little force), respectively. FIG. 13d is a perspective view of the alignment of the closing engagement roller (101r) with the first driving wheel (10M1) and of the axle engagement roller (102r) with the second driving wheel (10M2).

In the state engaged with the closing shaft (11) depicted in FIGS. 13c, 14c and 15c, the closing belt (11c) is clamped, on the one hand, between the closing wheel (11r) and the closing roller (101r) and, on the other hand, between the first driving wheel (10M1) and the closing engagement roller (110r), dividing the closing belt (11c) into a slack section (11c0) and a taut section (11c1). The taut section (11c1) of the closing belt (11c) is the section comprising the belt portion situated downstream of the first driving wheel (10M1), where the term “downstream” is defined relative to the direction of rotation of the first driving wheel (10M1). It is the taut section (11c1) that transfers the rotation movement of the first driving wheel (10M1) to the closing wheel (11r). It therefore important to maximize the area of contact between the taut section (11c1) and the rims of the first driving wheel (10M1) and the closing wheel (11). For this reason, the taut section (11c1) preferably has a length greater than that of the slack section (11c0) and wraps a maximum extent of the circumference of each of the first driving wheel (10M1) and the closing wheel (11r).

For example, if the driving shaft (10M) and the closing shaft (11) are aligned along an axis X11, the closing engagement roller (101r) is able to clamp the closing belt (11c) against the rim of the first driving wheel (10M1) at the level of the diameter of the first driving wheel (10M1) that is perpendicular to the axis X11. Similarly, the closing roller (110r) is able to press the closing belt (11c) against the closing wheel (11r) at the level of the diameter of the latter that is perpendicular to the axis X11. In this way, the taut section (11c1) of the closing belt (11c) wraps approximately half of the circumference of each of the first driving wheel (10M1) and the closing wheel (11r). In this way, the area of contact between the taut section (11c1) and each of the wheels (10M1, 11r) that it wraps is maximized, thereby optimizing the transfer of rotation movement from the first driving wheel (10M1) to the closing wheel (11r). It is clear that the closing engagement roller (101r) and the closing roller (110r) are able to press on the rim slightly upstream or downstream of the corresponding diameters that are perpendicular to the axis X11, but these diameters give a good indication of the optimum positions of the two rollers (101r, 110r). For example, the rollers (101r, 110r) can preferably clamp the closing belt (11c) in a zone within +10°, preferably +5°, around the point of intersection of the rims with corresponding diameters perpendicular to the axis X11. The FIGS. 13a to 15a identify the axes X11 and X12 and the diameters of the various wheels (10M1, 10M2, 11r, 12r) perpendicular to those axes for different alignments of the driving shaft (10M), the closing shaft (11) and the axle shaft (12). FIGS. 13b to 15b and 13c to 15c show that the axle engagement roller (102r) and closing engagement roller (101r) apply a force to the rim of the second and first driving wheels (10M2, 10M1) at the points of intersection with the diameters perpendicular to the axes X12 and X11, respectively.

In the state engaged with the closing shaft (11), the taut section (11c1) of the closing belt (11c) wraps a portion of the circumference of the first driving wheel (10M1) starting from the closing engagement roller (101r) and envelops a portion of the circumference of the closing wheel (11r) as far as the closing roller (110r). When the first driving wheel (10M1) is rotated by the motor (M) or the crank, the rotation movement is transmitted by friction to the taut section (11c1) of the closing belt (11c) which in turn transmits this rotation movement to the closing wheel (11r). As the axle engagement roller (102r) does not apply (or applies little) force against the second driving wheel (10M2), the axle belt (12c) is slack throughout its length and does not transmit the rotation movement of the second driving wheel (10M2) (synchronously with the first driving wheel (10M1)) to the axle wheel (12r).

In an analogous manner, in the state engaged with the axle shaft (12) depicted in FIGS. 13b, 14b and 15b, the axle belt (12c) is clamped, on the one hand, between the axle wheel (12r) and the axle roller (102r) and, on the other hand, between the second driving wheel (10M2) and the axle engagement roller (120r), dividing the axle belt (12c) into a slack section (12c0) and a taut section (12c1). The taut section (12c1) of the axle belt (12c) is the section comprising the belt portion situated downstream of the second driving wheel (10M2), where the term “downstream” is defined relative to the sense of rotation of the second driving wheel (10M2). It is the taut section (12c1) that transfers the rotation movement of the second driving wheel (10M2) to the axle wheel (12r). It is therefore important to maximize the area of contact between the taut section (12c1) and the rims of the second driving wheel (10M2) and the axle wheel (12). For this reason, the taut section (12c1) preferably has a length greater than that of the slack section (12c0) and wraps a maximum extent of the circumference of each of the second driving wheel (10M2) and the axle wheel (12r).

For example, if the driving shaft (10M) and the axle shaft (12) are aligned along an axis X12, the closing engagement roller (102r) is able to clamp the axle belt (12c) against the rim of the second driving wheel (10M2) at the level of the diameter of the second driving wheel (10M2) that is perpendicular to the axis X12. Similarly, the axle roller (120r) is able to press the axle belt (12c) against the axle wheel (12r) at the level of the diameter of the latter that is perpendicular to the axis X12. In this way, the taut section (12c1) of the axle belt (12c) wraps approximately half of the circumference of each of the second driving wheel (10M2) and the axle wheel (12r). In this way, the area of contact between the taut section (12c1) and each of the wheels (10M2, 12r) that it wraps is maximized, thereby optimizing the transfer of rotation movement of the second driving wheel (10M2) to the axle wheel (12r). It is clear that the axle engagement roller (102r) and the axle roller (120r) are able to press on the rim slightly upstream or downstream of the corresponding diameters that are perpendicular to the axis X12, but these diameters give a good indication of the optimum positions of the two rollers (102r, 120r). For example, the rollers (102r, 120r) are preferably able to clamp the axle belt (12c) against the rim of the corresponding wheels in a zone within ±10°, preferably ±5°, around the point of intersection of the rims with the corresponding diameters perpendicular to the axis X12.

In the state engaged with the axle shaft (12), the taut section (12c1) of the axle belt (12c) envelops a portion of the circumference of the second driving wheel (10M2) starting from the closing engagement roller (102r) and envelops a portion of the circumference of the axle wheel (12r) as far as the axle roller (120r). When the second driving wheel (10M2) is rotated by the motor (M) or the crank, the rotation movement is transmitted by friction to the taut section (12c1) of the axle belt (12c) which in turn transmits this rotation movement to the axle wheel (12r). As the closing engagement roller (101r) applies no (or little) force against the first driving wheel (10M1), the closing belt (11c) is slack over all its length and does not transmit the rotation movement of the first driving wheel (10M1) (synchronously with the second driving wheel (10M2)) to the closing wheel (11r).

This clutch system is advantageous for the following reasons:
The force to be applied by the closing engagement roller (101r) and the axle engagement roller (102r) to the belts (11c, 12c) and the corresponding wheels (10M1, 10M2, 11r, 12r) is weak, hardly a few N, for example, between 20 and 20 N, preferably between 50 and 100 N.
The movement of the structure necessary to go between the state engaged with the closing shaft and with the axle shaft is of small amplitude. The system can be equipped with a simple cylinder (5) to go between the states engaged with the closing shaft (11) and with the axle shaft (12).
This system is not affected by variations over time in the length of the belts (11c, 12c), which can vary because of creep or because of temperature variations, since the taut section is formed by the respective rollers (101r, 102r, 110r, 120r).
As the closing roller (110r) and the axle roller (120r) constantly apply a slight pressure to the closing wheel (11r) and the axle wheel (12r), the latter do not require a braking system (19) as discussed below because they are not able to turn out of control when they freewheel (i.e., when they are not coupled to the first or second driving wheel (10M1, 10M2)).
   Clutch System with Belts (11c, 12c) with Mobile Driving Shaft (10M)

In a second variant with belts (11c, 12c), depicted in FIGS. 2a and 2b to 4a and 4b, the driving shaft (10M) is mobile and enables passage alternately between the state engaged with the closing shaft and the state engaged with the axle shaft. FIGS. 2a, 3a and 4a depict examples of such a variant in the state engaged with the closing shaft (11) whereas FIGS. 2b, 3b and 4b show the same examples in the state engaged with the axle shaft (12).

In this first variant, the driving shaft (10M) is configured to be moved to vary a first distance separating it from the closing shaft (11) between a first engagement distance (L11) and a first disengagement distance (L10), and simultaneously to vary a second distance separating it from the axle shaft (12) between a second disengagement distance (L20) and a second engagement distance (L21). As seen in FIGS. 2a and 2b to 4a and 4b, the variation of the distances (L10, L11, L20, L21) separating the driving shaft from the closing shaft (11) and the axle shaft enables tensioning of one of either the closing belt or the axle belt (11c, 12c) whereas the other of the two belts is relaxed.

When the driving shaft (10M) is at the second engagement distance (L21) from the axle shaft (12), it is located at the first disengagement distance (L10) from the closing shaft (11) and the axle belt (12c) is taut whereas the closing belt (11c) is relaxed. The driving shaft then drives the rotation only of the axle wheel (12r) and the axle shaft (12), thus driving the movement of the drum (2t) in the opening sense (Do). Conversely, when the driving shaft (10M) is located at the first engagement distance (L11) from the closing shaft (11), it is located at the second disengagement distance (L20) from the axle shaft (12) and the closing belt (11c) is taut whereas the axle belt (12c) is relaxed. The driving shaft (10M) then drives the rotation only of the closing wheel (11r) and the closing shaft (11), thus driving the movement of the drum (2t) in the opening sense (Do).

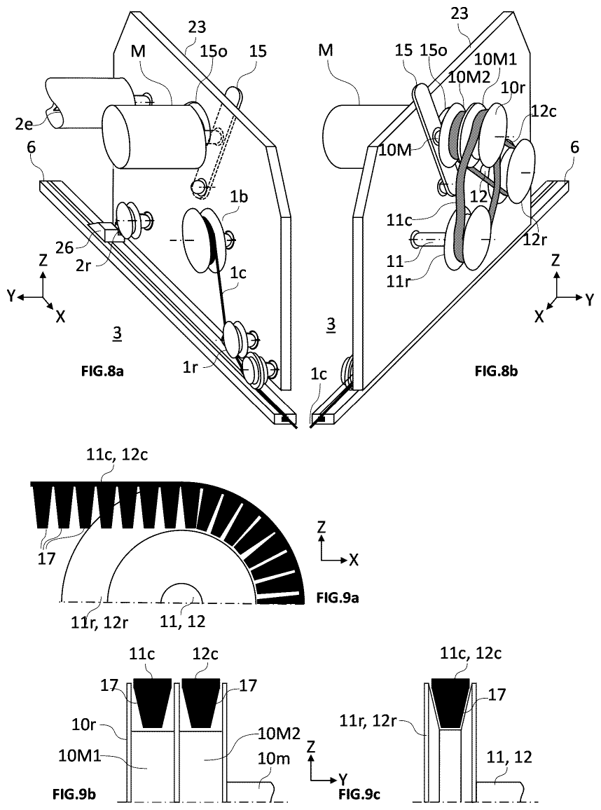

The driving shaft (10M) can be moved in linear translation between its positions engaged with the closing shaft and with the axle shaft. As depicted in FIGS. 8a, 8b and 17a, it is nevertheless preferable to mount the motor (M) and the driving shaft (10M) on a lever (15) mounted on a rotation shaft of the first chassis (23). By causing the lever (15) to pivot about its rotation axis, the motor (M) and the driving shaft are moved to the positions of engagement with the closing shaft and the axle shaft. If the motor (M) is located on the opposite face of the driving wheel (10r), the closing wheel (11r) and the axle wheel (12r), the driving shaft (10M) passes through an opening in the lever (150) drilled through the first chassis (23). In the case of a crank, the opening in the lever will generally not be necessary.

The lever (15) can be made accessible to an operator, for example by extending beyond a perimeter of the chassis (23), in order to enable it to be actuated manually. In a more sophisticated variant, the lever (15) can be coupled to an electric or pneumatic cylinder (5), as depicted in FIGS. 3a and 3b. It is important that the lever (15) can be locked at each of its positions engaged with the closing shaft and the axle shaft in order that it does not move during the movement of the drum. If a cylinder is used, it is sufficient to lock the cylinder. In a manual variant, it is preferable to provide any locking system, such as a recess in which the lever is reversibly accommodated at the end of its travel.

Clutch System with Belts (11c, 12c) with Engagement Roller (13r)

In a third variant with belts (11c, 12c), depicted in FIGS. 5a and 5b, the driving shaft (10M) is fixed. The clutch system comprises a mobile engagement roller (13r) enabling passage alternately between the state engaged with the axle shaft (12) (cf. FIG. 5a) and engaged with the closing shaft (11) (cf. FIG. 5b).

In this variant, the driving shaft (10M), the closing shaft (11) and the axle shaft (12) are at fixed positions relative to one another and separated from one another so that the closing and axle belts (11c, 12c) are both relaxed. The clutch system further comprises an engagement roller (13r) connected to a mobile shaft, parallel to the driving shaft (10M), the closing shaft (11) and the axle shaft (12). As depicted in FIGS. 5a and 5b, the shaft of the engagement roller (13r) is mobile in the sense that it can be moved between
a first engagement position in which the engagement roller (13r) presses on the closing belt (11c) to tension it between the driving wheel (10r) and the closing wheel (11r) thereby defining the state of engagement with the closing shaft (11), and
a second engagement position in which the engagement roller (13r) presses on the axle belt (12c) to tension it between the driving wheel (10r) and the axle wheel (12r) thereby defining the state of engagement with the axle shaft (12).

The engagement roller (13r) can be moved in linear translation between its first and second engagement positions. Alternatively, the engagement roller (13r) can be mounted on a lever (not depicted) mounted on a rotation shaft on the first chassis (23). By causing the lever to pivot about its rotation axis, the engagement roller (13r) can be moved to the first and second engagement positions.

The movement of the engagement roller (13r) can be effected manually for example with the aid of a lever (15) or automatically with the aid of a cylinder (neither of which is depicted).

Clutch System with Mobile Driving Shaft (10M) and without Belts

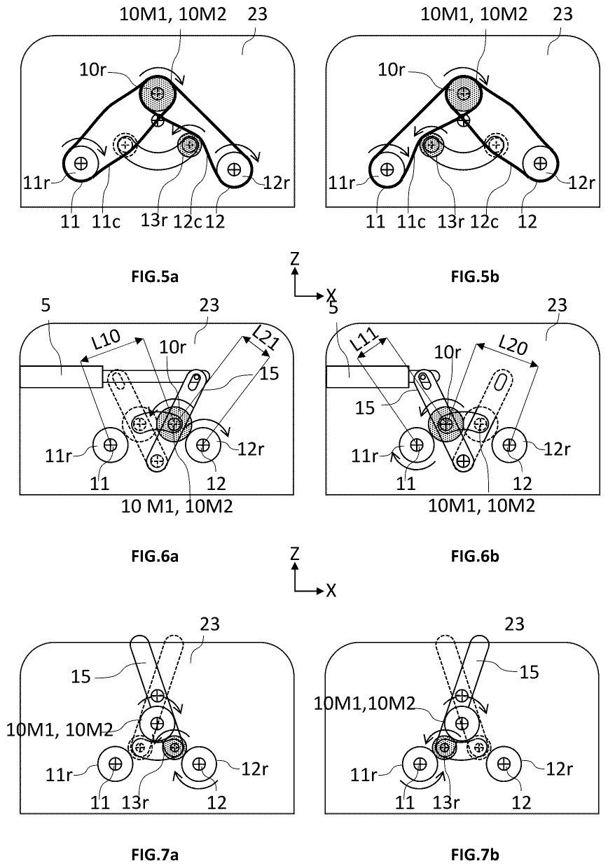

In a variant of the invention depicted in FIGS. 6a and 6b and 7a and 7b, the clutch system does not comprise belts. In this variant, the clutch system comprises
a closing wheel (11r) configured to turn with the closing shaft (11),
an axle wheel (12r) configured to turn with the axle shaft (12),
a driving wheel (10r) configured to turn with the driving shaft (10M).

In the example depicted in FIGS. 6a and 6b, the driving shaft (10M) is mobile between a closing position defining the state of engagement with the closing shaft (11) and an axle position defining the state of engagement with the axle shaft (12). In the closing position, the first driving wheel (10M1) is in rubbing contact with the closing wheel (11r) thereby defining the state of engagement with the closing shaft (11) and is separated from the axle wheel (12r). Conversely, in the axle position, the second driving wheel (10M2) is in rubbing contact with the axle wheel (12r) thereby defining the state of engagement with the axle shaft (12) and is separated from the closing wheel (11r). Two wheels are “in rubbing contact” if the rotation of a first wheel drives the rotation of the second wheel. The angular speed (w2) of the second wheel is preferably at least 95% of the angular speed (w1) of the first wheel with less than 5% losses of the moment of rotation (i.e., |w2|≥95%|w1|). The wheels may be toothed pinions or wheels without teeth but with rims adhering to one another, for example with a structure, or a high coefficient of friction.

As in the clutch system with mobile driving shaft and two belts discussed hereinabove, the driving shaft (10M) can be moved in linear translation between its positions engaged with the closing shaft and the axle shaft. As depicted in FIGS. 6a and 6b, it is nevertheless preferable to mount the motor (M) and the driving shaft (10M) on a lever (15) mounted on a rotation shaft on the first chassis (23). By causing the lever (15) to pivot about its rotation axis, the motor (M) and the driving shaft are moved to the closing and axle positions. If the motor (M) is located on the face opposite the driving wheel (10r), the closing wheel (11r) and the axle wheel (12r), the driving shaft (10M) passes through an opening in the lever (150) drilled through the first chassis (23). In the case of a crank, the opening in the lever will generally not be necessary.

The lever (15) can extend beyond a perimeter of the chassis (23) in order to enable it to be actuated manually. In a more sophisticated variant depicted in FIGS. 6a and 6b, the lever (15) can be coupled to an electric or pneumatic cylinder (5). It is important that the lever (15) can be locked in each of its closing and axle positions in order not to move during the movement of the drum. If a cylinder is used, it suffices to lock the cylinder. In a manual variant, it is preferable to provide any locking system, such as a recess in which the lever is reversibly housed at the end of its travel.

Clutch System with Engagement Roller (13r) and without Belts

In a second variant without belts, depicted in FIGS. 7a and 7b, in which the clutch system comprises a closing wheel (11r), an axle wheel (12r), a driving wheel (10r), the driving shaft (10M), the closing shaft (11) and the axle shaft (12) are this time in fixed positions relative to one another and separated from one another so that the driving wheel (10r), the closing wheel (11r) and axle wheel (12r) do not touch each other. The device further comprises an engagement roller (13r) connected to a shaft parallel to the driving shaft (10M), the closing shaft (11) and the axle shaft (12). The shaft of the engagement roller (13r) can be moved between a position in contact with the closing wheel defining the state engaged with the closing shaft and a position in contact with the axle defining the state engaged with the axle shaft.

In the position of contact with the closing wheel depicted in FIG. 7b, the engagement roller (13r) is in rubbing contact with the first driving wheel (10M1) and the closing wheel (11r) forming a transmission system between the first driving wheel (10M1) and the closing wheel (11r). The axle wheel (12r) being separated from the second driving wheel (10M2), the axle wheel (12r) is not activated in rotation by the simultaneous rotation of the first and second driving wheels (10M1, 10M2). In the position in contact with the axle depicted in FIG. 7a, the engagement roller (13r) is in rubbing contact with the second driving wheel (10M2) and the axle wheel (12r) forming a transmission system between the second driving wheel (10M2) and the axle wheel (12r). As the closing wheel (11r) is separated from the first driving wheel (10M1), the closing wheel (11r) is not activated in rotation by the rotation of the first driving wheel (10M1).

The shaft of the engagement roller (13r) can be moved in linear translation between its positions in contact with the closing wheel and with the axle. As depicted in FIGS. 7a and 7b, it is nevertheless preferable to mount the shaft of the engagement roller (13r) on a lever (15) mounted on a rotation shaft on the first chassis (23). By causing the lever (15) to pivot about its rotation axis, the engagement roller (13r) is moved to the positions in contact with the closing wheel and with the axle.

The lever (15) can be made accessible to an operator, for example by extending beyond a perimeter of the chassis (23), in order to enable it to be actuated manually. In a more sophisticated variant, the lever (15) may be coupled to an electric or pneumatic cylinder (5) (not depicted). It is important that the lever (15) can be locked in each of its positions engaged with the closing and axle shafts in order not to move during the movement of the drum. If a cylinder is used, it suffices to lock the cylinder. In a manual variant, it is preferable to provide any type of locking system, such as a recess in which the lever is reversibly housed at the end of its travel.

In the variants without belts described hereinabove, the rubbing contact between the first or second driving wheel (10M1, 10M2) and the various closing wheels (11r), axle wheels (12r) or engagement wheels (13r) must not allow slipping, i.e., |wi|≥95%|w0|, where w0 is the angular speed of the first and second driving wheels (10M1, 10M2) of the drive system (10r) and wi is the angular speed of the closing wheel (11r), axle wheel (12r) or engagement wheel (13r) in rubbing contact with the first or second driving wheel (10M1, 10M2). The driving wheel (10r), the closing wheel (11r), the axle wheel (12r) and the engagement wheel (13r) may therefore be toothed wheels (pinions) or have adherent rim surfaces with a high coefficient of friction. For example, the exterior surface of the rims can be structured and/or made of an elastomer material such as a rubber.

### Control of the Rotation of the Shaft Under No Load Conditions

In the state engaged with the closing shaft, the driving shaft (10M) actuates the rotation of the closing shaft (11), thereby moving the drum (2t) in the closing sense (Dc). The axle shaft (12) is not actuated in rotation by the driving shaft (10M) and freewheels. In fact, even if it is not driven by the driving shaft (10M), the axle shaft (12) turns while the drum (2t) is moved in the closing sense (Dc) by the traction force exerted on the cover by its second transverse edge fixed to the second width of the surface (3).

Similarly, in the state engaged with the axle shaft, the driving shaft (10M) actuates the rotation of the axle shaft (12), winding the cover (9) onto the drum and moving the drum (2t) in the opening sense (Do) by the force exerted on the cover by its second transverse edge fixed to the second width of the surface (3). The closing shaft (11) is not actuated in rotation by the driving shaft (10M) and freewheels. In fact, even though not driven by the driving shaft (10M), the closing shaft (11) turns while the drum (2t) is moved in the opening sense (Do) by the traction force exerted on the closing cords (1c) by their end fixed to the second width of the surface (3).

It is important to ensure that the freewheeling of the closing shaft (11) and the axle shaft (12) remains under control, in order to prevent runaway of their rotation with the formation of slack in the cover (9) and the closing cords (1c), respectively, which could disrupt the correct functioning of the device.

Although the motor of the two motors (M1, M2) described in WO2023011789 that was not actuated offered too high a resistance to the rotation of the shaft coupled to the motor in action for good functioning of the system, no resistance to the free rotation of the shafts can, in some cases, also cause damage. For this reason, it may be necessary in some cases to apply controlled braking of the free rotation of the shaft that is not engaged. To control the free rotation of the closing wheel (11) and the axle wheel (12), a controlled friction force may be applied in order to prevent them from turning too quickly and forming slack in the closing cords (1c) and in the cover (9), respectively. There exist various solutions for applying a friction force to the wheels when they are free to rotate (i.e., not engaged with the transmission shaft).

In the variant of the clutch system depicted in FIGS. 13a to 15c, the risk of runaway when the closing wheel (11r) or the axle wheel (12) is freewheeling does not occur, because the closing roller (110r) and the axle roller (120r) apply a force against the rim of the closing wheel (11r) and axle wheel (12r) preventing loss of control of the freewheeling rotation. In the other variants using a closing belt (11c) and an axle belt (12c), the free rotation of the closing wheel (11r) and the axle wheel (12r) can be controlled by providing a large area of contact between the belt and the corresponding wheel. For example, as depicted in FIGS. 9a to 9c, the belts (11c, 12c) can be provided with teeth (17) making it possible, on the one hand, to increase the thickness of the belt, as can be seen in FIG. 9a, and, on the other hand, to preserve the necessary flexibility for the belt to wrap the driving wheel (10r), the closing wheel (11r) and the axle wheel (12r). The closing wheel (11r) and the axial wheel (12c) are provided with channels configured to receive the corresponding belt. As depicted in FIG. 9c, the geometry of the channels espouses the geometry of the teeth (17) of the belts creating friction forces between the belts and the walls of the channel of each wheel. When a belt is relaxed in the state disengaged from the corresponding shaft, it brakes the free rotation of the wheel by friction, thereby preventing excessive rotation of the disengaged wheel. As depicted in FIGS. 8b and 9b, the drive system (10r) comprises first and second driving wheels (10M1, 10M2) coaxial with the driving shaft (10M), configured to receive the closing belt (11r) and the axle belt (12r), respectively. The first and second driving wheels (10M1, 10M2) preferably each comprise a channel to accommodate without slipping the closing belt (11c) and the axle belt (12c). For example, the channels may have a geometry offering less friction to the belts than the corresponding closing wheel (11r) and axle wheel (12r), as depicted for example in FIG. 9b compared to FIG. 9c.

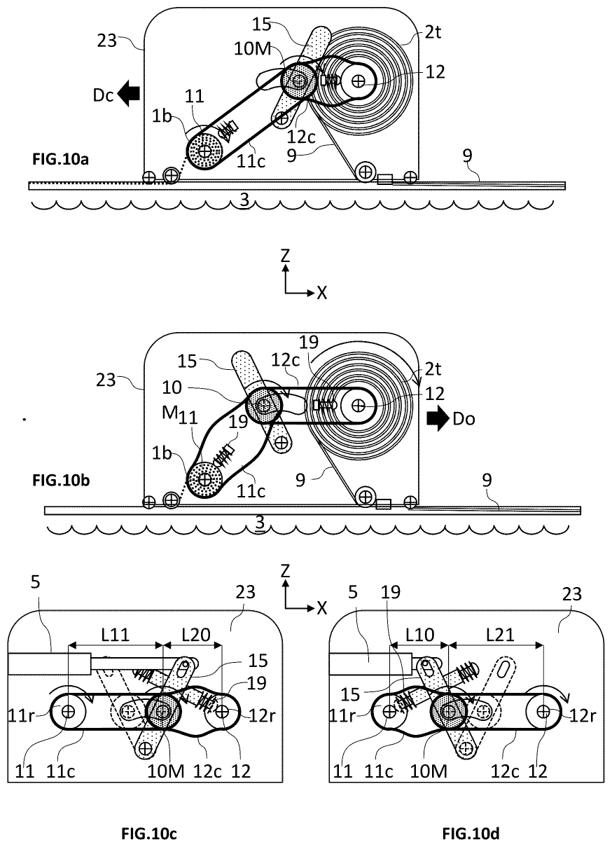

In an alternative variant, applying to clutch systems with or without belts (11c, 12c), depicted in FIGS. 10a to 10d, the device comprises a brake (19) configured to exert a pressure on the wheel, the shaft, or even the belt portion wrapping the wheel, configured to brake by friction and in a controlled manner the rotation of the free wheel. The brake is preferably mounted on a resilient system enabling control of the applied pressure. It is preferable for the brake to act only on the wheel or the shaft that is disengaged and not on the wheel or the shaft that is engaged. If the clutch system comprises a lever (15) for passing from the state engaged with the closing shaft to that engaged with the axle shaft, the brake (19) may be mechanically connected to the lever (15) so as selectively to apply pressure to a wheel depending on the position of the lever (15), as depicted in FIGS. 10c and 10d.

### Locking of the Longitudinal Edges of the Cover (9)

In many applications, it is advantageous to lock the longitudinal edges of the cover as and when it is deployed. This is particularly beneficial in the case of swimming pools, because this makes it possible to prevent persons present on the cover being thrown into the water through a gap between the longitudinal edge of the cover and the edge of the swimming pool. Furthermore, sealing the peripheral zone of contact between the cover and the longitudinal edges of the surface can prevent the introduction into the swimming pool of dirt, dead leaves and twigs as well as small animals such as mice or snakes. This also opens up the possibility of pressurizing the volume of air located between the surface of the water and the lower surface of the cover, in order to inflate the latter.

The device of the present invention comprises an insertion system (26) rigidly fixed to the chassis on each side of the surface to be covered and configured so that once inserted in the space (14e) by the insertion system, the bead (9j), on the one hand, cannot leave it due only to the action of a force (F) applied parallel to the transverse axis (Y) in the direction of the surface to be covered, and, on the other hand, can escape from it when winding the cover (10) onto the drum (2t) moving in the opening sense (Do) driving the withdrawal of the cover (9). Insertion systems may be implemented in the present invention as described for example in WO2012171658, WO2023011789, WO2010/010152, WO2010054960 or WO2014064138.

### Locking the Bead (9j), Present Alone in the Groove

WO2012171658 and WO2023011789 describe a system for inserting and locking the bead (9j) in the opening (14) in the corresponding rail (6), with the bead occupying alone the space (14e). An example of such a system is depicted in FIGS. 11a to 11d.

The bead (9j) may be continuous or discontinuous, i.e., made up of discrete elements fixed side-by-side along the corresponding longitudinal edge. In section on a plane normal to the longitudinal edge of the cover, the bead (9) has an elongate geometry defined by a ratio (D/d) of a first diameter (D) to a second diameter (d) greater than unity (i.e. D/d>1), in which the first diameter (D) is defined as the length of the straight line connecting the two points farthest away from each other of the perimeter of the geometry and the second diameter (d) is the length of the longest straight line perpendicular to the first diameter (D) that connects two points of the perimeter. Preferably, the ratio D/d>1.3, preferably D/d>1.5.

In a cross section normal to the longitudinal axis (X), the opening (14) of the groove has a maximum width (Lo) and the space (14e) has a maximum width (Le) greater than the maximum width (Lo) of the opening (14) (Lo<Le), where the maximum widths (Lo, Le) are measured parallel to the transverse axis (Y). The bead (9j) on each longitudinal edge and the groove of the corresponding rail are configured so that once inserted in the space (14e) by the insertion system, the projecting element occupying alone the space (14e) cannot escape from it only by the action of a force (F) applied parallel to the transverse axis (Y) in the direction of the surface to be covered.

For example, in the variant depicted in FIGS. 11a to 11d, showing a rail having a groove characterized by an opening (14) of width Lo and a space (14e) of width Le>Lo, and a bead having a ratio, D/d>1, such that d<Lo<D, in the closing sense (Dc) of translation of the drum (2t), the insertion system (26) is configured to guide, position and orient the bead (9j) through the opening (14) of the corresponding rail having a diameter between d and D inclusive and less than Lo. Once inserted through the opening (14) into the space (14e), the bead (9j) spontaneously changes orientation because of the traction exerted by the cover in tension from one longitudinal edge to the other. Because of this change of orientation, seen in FIGS. 11b and 11c, the bead has a dimension greater than the maximum width (Lo) of the opening (14) and is therefore locked. Unlocking during translation of the drum (2t) in the opening sense (Do) employs the same mechanism in reverse, with an orientation of the bead such as to offer a diameter between d and D inclusive and less than Lo, in order to enable the bead to escape from the groove and the cover (9) to be wound around the drum (2t).

Other examples of reversible locking of the bead (9j) in the groove of the rail (6) are described in WO2012171658 and may be applied to the device of the present invention. For example, the bead may be elastically compressible, enabling reduction of its second diameter d during insertion of the bead, such that d<Lo. In another example, the bead (9j) is formed by a cable in the form of consecutive turns forming a coil spring, the axis of which is parallel to the corresponding longitudinal edge of the cover (9), in which the turns are defined so that,
in a rest configuration, the minimum diameter (d) measured parallel to the transverse axis (Y) of each turn at rest is equal to do between the maximum widths (Lo, Le) of the opening (14) and of the space (14e) of the corresponding rail inclusive (Lo<d0<Le), and
in a deformed configuration, the angle between the deformed turns and the longitudinal axis (X) is modified so that the minimum diameter (d1) measured in a plane normal to the longitudinal axis (X) of each deformed turn is less than or equal to the maximum width (Lo) of the opening (14) of the corresponding rail (d1≤Lo).

The insertion system enables local deformation of the turns in their deformed configuration during their insertion through the opening (14) of the corresponding rail (6), the turns recovering their rest configuration once they are located in the space (14e).

### Locking the Bead (9j) by Action of the Closing Cord (1c) or a Locking Belt (7c)

WO2010/010152, WO2010054960 and WO2014064138 describe a system for locking the bead (9j) in the groove of the rails (6) that uses a locking belt (7c). In this variant, depicted in FIGS. 16a to 16c and 17a to 17c, the groove in each rail is partially closed by a flange (6a) on the side of the surface (3) to be covered. The device comprises for each rail (6) a locking belt (7c) fixed to each end of the rail (6). In the FIG. 16a variant, the locking belt (7c) is formed by the closing cord (1c). Each locking belt (7c) or closing cord (1c) is housed in the groove between each end of the rail (6) and the corresponding chassis (23) and exits the groove at the level of the corresponding chassis because of the action of idler pulleys (1r, 7r). The cover (9) wrapped around the axle (2e) and partially deployed over a part of the surface (3) is not represented in FIGS. 16a and 17a (or FIG. 8a) to clarify the figures.

In the variant depicted in FIGS. 16a to 16c, the translation system is as described in the section entitled “Closing system with fixed closing cords (1c)” above and depicted in FIGS. 1a, 12a to 12d, in which a preferably notched closing cord (1c) is fixed to each end of each rail (6) and extends in the space (14e) of the corresponding rail upstream and downstream of the chassis (23) relative to the closing sense (Dc). Idler pulleys (1r) extract the closing cord (1c) from the groove of each upstream and downstream side of the chassis (23) that wraps without slipping a closing spool (1b). The closing spool (1b) is rigidly fixed to the closing shaft (11) and turns with and around the closing shaft (11). The rotation of the closing shaft (11) drives the rotation of the closing spool (1b), which “rolls” along the closing cord (1c), thus moving the chassis (23) and the drum (2t) in the closing sense (Dc), bringing about the unwinding of the cover (9) the second transverse edge of which is fixed to the second width of the surface to be covered. While the cover is unwound, the bead is introduced into the space (14e) through the opening (14) by the insertion system (2r, 26). The idler pulley (1r) situated on the upstream side of the chassis is configured to introduce the closing cord (1c) into the groove upstream of the position in which the bead is introduced into the space (14e) of the rail. As depicted in FIGS. 12c et 16b, the closing cord (1c) installed in the space (14e) upstream of the chassis (23) obstructs a significant part of the opening (14) thereby locking the bead (9j) into the space (14e) under the flange (6a). The cover (9) is therefore firmly locked into the groove of each rail (6).

This variant of the invention is preferred because the closing cords (1c) enable both movement of the drum (2t) in the closing sense (Dc) and locking of the beads (9j) of the cover (9) in the groove of the rails (6) as and when the cover (9) is placed over the surface (3).

The variant depicted in FIGS. 17a to 17c uses the same locking system as in the variant from FIGS. 16a to 16c, but a different translation system, discussed in the section entitled “Closing system with winding of closing cords (1c)” depicted in FIGS. 1b, 8a, 10a and 10b (and 17a). The device therefore comprises a closing cord (1c) used only to drive the translation of the drum (2t) in the closing sense, and a locking belt (7c) used only to lock the bead (9j) of the cover (9) in the groove of each rail (6). It should be remembered that these two functions are fulfilled by the single closing cord (1c) in the variant discussed above with reference to FIG. 16a.

As depicted in FIG. 17a, the idler pulleys (7r) are configured, like the idler pulleys (1r) of the FIG. 16a variant discussed above, to insert the locking belt (7c) into the groove upstream of the insertion system (26) in order to wedge the bead (9j) under the flange (6a) leaving an open space in the opening (14) insufficient to allow the bead to leave the groove via the opening (14). The terms “upstream” and “downstream” are defined here relative to the closing sense (Dc). In a preferred variant depicted in FIGS. 17a and 17c, the idler pulleys (7r) are configured to insert the locking belt (7c) in the groove downstream of an idler pulley (1r) configured to insert the closing cord (1c) in the groove of the corresponding rail, in order to house the closing cord (1c) under the flange (6a) alongside the locking belt (7c) as depicted in FIG. 17c.

### Insertion System (26)

The insertion system (26) comprises idler rollers (2r) (not depicted in detail) making it possible, on the one hand, to tension the cover in the transverse direction, in order to locate the bead (9j) vertically in alignment with the opening (14) of the groove and, on the other hand, to insert the bead (9j) in the groove so that it remains locked therein as explained above. The geometry of the insertion system depends on the geometry of the bead and the groove, as well as of the locking mechanism with or without a locking belt (7c).

Locking systems for different insertion mechanisms are described in WO2010054960, WO2017130053, WO2021170500 and WO2023144062. These mechanisms or variations thereof can be used in the device of the present invention without diminishing its inventiveness.

### Opening and Closing of the Surface

As depicted in FIG. 10b, the translation of the drum in the opening sense (Do) necessitates activation of the rotation of the axle shaft (12) to cause the drum (2t) to turn and thus to apply a traction force to the cover, the second transverse edge of which is fixed to the second width of the surface (3), allowing the closing shaft (11) to turn freely, where necessary with controlled braking with the aid of a brake (19), for example, in order to withdraw the cover from the surface. As depicted in FIG. 10a, the activation of the rotation of the closing shaft (11) is required to move the drum in the closing sense (Dc) by allowing the free rotation of the axle shaft (12), if necessary with controlled braking with the aid for example of a brake (19), in order to deploy the cover over the surface. The rotation of the driving shaft (10M) is preferably actuated by a motor (M), but can also be actuated by a crank. The motor (M) is preferably an electric motor preferably coupled to a battery powered by a solar panel. The rotation means (M1, M2) of the drum axle (2e) and the closing axle (1) are preferably electric motors.

In most cases and as depicted in FIG. 1a, only one motor (M) or one crank associated with the clutch system mounted on the only one first chassis is sufficient to control the translation of the drum (2t) in both of the closing sense (Dc) and the opening sense (Do). In order to turn synchronously the closing spools (1b) mounted on the first and second chassis (23), the closing shaft (11) of the first chassis extends parallel to the transverse axis (Y) as far as the closing spool (1b) of the second chassis (23) so that the rotation of the closing spool (1b) of the first chassis (23) drives the rotation of the closing spool (1b) of the second chassis.

However, in some cases, notably for covers of large size, especially in the transverse direction, it may be preferable to mount a motor (M) associated with the clutch system on each of the two chassis supporting the drum (2t), as depicted in FIG. 1b. It is no longer necessary for the closing shaft (11) to extend from the closing spool (1b) of the first chassis to the closing spool (1b) of the second chassis since each chassis (23) is equipped with its own motor (M) and clutch system. It is obviously necessary for the two motors (M) on each side of the drum (2t) to be synchronous, which is easy to control.

In order to cover the surface (3), the drum (2t) must be moved in the closing sense (Dc). In the variant in which the closing cords (1c) are wound around the closing spools (1b), as depicted in FIG. 10a, when the clutch system is set in its state engaged with the closing shaft (11), the rotation of the closing shaft (11) drives the rotation of the closing spools (1b) that wind in the corresponding closing cords (1c). As one end of each closing cord (1c) is fixed to the first width of the surface (3), the rotation of the closing spools (1b) creates a traction force on the closing cords (1c) that enable the translation of the drum (2t) toward the first width of the surface (3) in the closing sense (Dc). In the variant movement with closing cords (1c) fixed at each corner of the surface (3) and wrapping the closing spool (1b), as discussed with reference to FIGS. 1a and 16a, the rotation of the closing shaft (1b) causes the closing spool (1b) to turn, so that it “rolls” along the corresponding closing cord (1c).

As the drum moves away from the second width of the surface (3), where the second transverse edge of the cover is fixed, the cover section covering the surface portion (3) upstream of the drum (in the closing sense (Dc)) is tensioned and creates a traction force spontaneously activating the rotation of the drum, which is free in this rotation sense (if necessary braked in a controlled manner) and therefore unwinds the cover (10) as and when the drum moves in the closing sense (Dc). As and when the drum (2t) moves in the closing sense (Dc) toward the first width of the surface, the cover (9) is deployed over the surface (3) and the insertion system (26) introduces the bead (9j) of the cover (9) into the groove of the corresponding rail, in which it is locked, until the drum reaches the first width of the surface (3), thus covering the surface (3).

In order to uncover the surface (3), the drum (2t) must be moved in the opening sense (Do). As represented in FIG. 10b, the clutch system is then set in its state engaged with the axle shaft (12) and the rotation of the axle (2e) winds the cover onto the drum (2t). As the second transverse edge of the cover (9) is fixed to the second width of the surface (3), the rotation of the drum (2t) and the subsequent winding of the cover (9) create a traction force on the deployed cover portion (9) that enables the translation of the drum (2t) toward the second width of the surface (3) in the opening sense (Do). Depending on the translation system in the closing sense (Dc) used, while the drum moves away from the first width of the surface (3), where one end of each closing cord (1c) is fixed, the closing cords (1c) are unwound from the closing spools (1b) which freewheel or the closing spools (1b) “roll” by freewheeling along the closing cords (1c). If necessary the free rotation of the closing wheels is braked in a controlled manner in order to keep the closing cords (1c) under tension, as discussed above.

As the drum moves in the opening sense (Do), moving toward the second width of the surface, the cover (9) is removed from the surface (3) and the insertion system (26) is unlocked and extracts the bead (9j) of the cover (9) from the groove of the corresponding rail, thereby allowing winding of the cover (9) onto the drum (2t) until the drum reaches the second width of the surface (3), thereby exposing the uncovered surface (3).

The device may comprise at least first and second anti-lifting guides (not depicted) comprising an external portion coupled to the corresponding first and second chassis (23) and an internal portion inserted in the space (14e) of the corresponding rail, so as to be able to slide freely along the rails parallel to the longitudinal axis (X) and not being extractable from the rails (6) by application of a force perpendicular to the longitudinal axis (X).

### CONCLUDING REMARKS

Compared to a translation system comprising two motors for actuating the rotation of the drum and the spool, as described in WO2023011789, the use of a single motor (M) coupled to a clutch system as described above makes it possible, on the one hand, to economize on the cost of purchase and installation of a second motor and, on the other hand, not to have to overcome the substantial resistance produced by the motor that is not activated. This enables the use of a lower power motor that is therefore less bulky and less costly. In some cases, the free rotation of the closing spools (1b) or of the drum (2t) must be controlled by applying an appropriate friction force, which is much less than the resistance produced by the motor that is not activated. The system can be configured so that the motor (M) or crank always turns in the same rotation sense whether the drum (2t) is moved in the closing sense (Dc) or the opening sense (Do). Obviously, it is equally possible to cause the motor (M) to turn in different rotation senses by changing the winding direction of the closing spools (1b) or of the drum (2t).

The clutch system may be adjusted between the state engaged with the closing shaft (11) or with the axle shaft (12) manually or using a preferably electric or pneumatic or hydraulic cylinder (5).

Compared to a translation system as described in WO2010054960 comprising a torsion spring for actuating the rotation of the drum (2t) during its translation in the opening sense (Do) that does not use a motor, the device of the present invention offers the enormous advantage of having no torsion spring, which is costly, heavy, complex to mount and dangerous in the case where the translation mechanism is handled by an unqualified person. As the motor must not stiffen the torsion spring during the translation of the drum (2t) in the closing sense (Dc), a lower power motor may be used which is therefore less bulky and less costly.

A preferred variant of the device of the present invention comprises
a closing system as discussed in the section entitled “Closing system with fixed closing cords (1c)” with reference to FIGS. 1a and 16a, and/or
a locking system as discussed in the section entitled “Locking the bead (9j) by action of the closing cord (1c) or a locking belt (7c)” with reference to FIGS. 16a and 16b, and/or
a clutch system as discussed in the section entitled “Clutch system with belts (11c, 12c) with mobile closing engagement roller (101r) and axle engagement roller (102r)” with reference to FIGS. 13a to 15c.

| REF | FEATURE |
|---|---|
| 1b | Closing spool |
| 1c | Closing belt |
| 1r | Idler pulley redirecting the closing cords toward the spool |
| 2c | Axle belt |
| 2e | Axle |
| 2r | Idler pulley redirecting the cover toward the axle |
| 2t | Drum |
| 3 | Surface to be covered |
| 5 | Cylinder |
| 7c | Locking belt |
| 7r | Idler pulley of the locking belt |
| 9 | Cover |
| 9j | Bead |
| 10M | Driving shaft |
| 10M1 | First driving wheel |
| 10M2 | Second driving wheel |
| 10r | Drive system |
| 11 | Closing shaft |
| 11c | Closing belt |
| 11r | Closing wheel |
| 12 | Axle shaft |
| 12c | Axle belt |
| 12r | Axle wheel |
| 13r | Engagement roller |
| 15 | Lever of the clutch system |
| 15o | Opening in the lever |
| 17 | Teeth of the closing and axle belts |
| 19 | Freewheel brake |
| 23 | Chassis |
| 101r | Closing engagement roller |
| 102r | Axle engagement roller |
| 110r | Closing roller |
| 120r | Axle roller |
| L10 | First disengagement distance between the |
| | driving shaft and the closing shaft |
| L11 | First engagement distance between the |
| | driving shaft and the closing shaft |
| L20 | Second disengagement distance between |
| | the driving shaft and the axle shaft |
| L21 | Second engagement distance between |
| | the driving shaft and the axle shaft |
| M | Motor |

1. A device for covering a surface (3) contained within a rectangle with first and second lengths extending parallel to a longitudinal axis (X) and first and second widths extending parallel to a transverse axis (Y), normal to the longitudinal axis (X), the device comprising:
a substantially rectangular cover (9) with dimensions equal to those of the rectangle and having
first and second transverse edges opposite one another, the second transverse edge of the cover being fixed to the second width of the surface to be covered, and
first and second longitudinal edges opposite one another, each longitudinal edge being provided with a bead (9j) forming a projecting element, extending along each longitudinal edge,
two rails (6) placed on respective opposite sides of said surface (3) parallel to the longitudinal axis (X), each rail consisting of a profiled member having an opening (14) on one of its faces oriented away from the surface to be covered and forming a groove extending all along each rail,
a drum (2t) comprising an axle (2e) mounted to rotate on first and second chassis (23) at each of two ends of the axle and supporting the cover (9) able to wind and to unwind the cover (9) fixed to the axle by its first transverse edge, the drum (2t) being mounted on a longitudinal translation mechanism enabling longitudinal translation of the drum along the two rails,
in an opening sense (Do) parallel to the longitudinal axis (X) enabling winding of the cover and its withdrawal from said surface (3), driven by the rotation of the axle (2e) about an axle shaft (12),
in a closing sense (Dc) parallel to the longitudinal axis (X) enabling unwinding of the cover and its deployment over the surface (3) to be covered, driven by the rotation of first and second closing spools (1b) mounted to rotate about a closing shaft (11) on the first and second chassis (23) and coupled to first and second closing cords (1c) configured to drive the movement of the drum in the closing sense during the rotation of the first and second closing spools (1b),
an insertion system (2r, 26) coupled to the chassis on respective opposite sides of the surface to be covered and configured,
to insert and to lock the bead (9j) of each longitudinal edge of the cover in the opening (14) of the corresponding rail (6) during the translation in the closing sense (Dc) of the drum driving the unwinding of the cover, and
to unlock and to extract the bead (9j) on each longitudinal edge of the cover out of the opening (14) of the corresponding rail (6) during the translation in the opening sense (Do) of the drum driving the winding of the cover,
wherein a single motor (M) or crank is mounted on the first chassis (23) and is configured to drive the rotation of a driving shaft (10M) and wherein the device comprises a clutch system configured so that the rotation of the driving shaft (10M) drives only the rotation of one of the closing shaft (11) and the axle shaft (12) at a time, passing between
a state engaged with the axle shaft (12) so as to transmit a rotation movement of the driving shaft (10M) to the axle shaft (12) to move the drum (2t) in the opening sense (Do), and
a state engaged with the closing shaft (11) so as to transmit a rotation movement of the driving shaft (10M) to the closing shaft (11) to move the drum (2t) in the closing sense (Dc).

2. The device as claimed in claim 1, in which the clutch system comprises
a closing wheel (11r) configured to turn with the closing shaft (11),
an axle wheel (12r) configured to turn with the axle shaft (12),
a drive system (10r) comprising first and second driving wheels (10M1, 10M2) mounted coaxially and rigidly on the driving shaft (10M) and configured to turn with the driving shaft (10M),
a closing belt (11c) forming a closed loop connecting the first driving wheel (10M1) to the closing wheel (11r),
an axle belt (12c) forming a closed loop connecting the second driving wheel (10M2) to the axle wheel (12r),
in which,
in the state engaged with the closing shaft (11), the closing belt (11c) is at least partly tensioned, so that the rotation of the first driving wheel (10M1) drives the rotation of the closing wheel (11r), while the axle belt (12c) is relaxed,
in the state engaged with the axle shaft (12), the axle belt (12c) is at least partly tensioned, so that the rotation of the second driving wheel (10M2) drives the rotation of the axle wheel (12r), while the closing belt (11c) is relaxed.

3. The device as claimed in claim 2, in which the driving shaft (10M), the closing shaft (11) and the axle shaft (12) are at fixed positions relative to one another and separated from one another so that the closing and axle belts (11c, 12c) are both relaxed, and in which the clutch system comprises
a closing roller (110r) pressing the closing belt (11c) against the closing wheel (11r),
an axle roller (120r) pressing the axle belt (12c) against the axle wheel (12r),
a closing engagement roller (101r) and an axle engagement roller (102r) mounted on a structure configured to move the closing engagement roller (101r) and the axle engagement roller (102r) between the state engaged with the closing shaft (11) and the state engaged with the axle shaft (12), in the following manner,
in the state engaged with the closing shaft (11), the closing engagement roller (101r) is moved until it presses the closing belt (11c) against the first driving wheel (10M1), while the axle engagement roller (102r) applies no or less pressure to the axle belt (12c), and
in the state engaged with the axle shaft (12), the axle engagement roller (102r) is moved until it presses the axle belt (12c) against the second driving wheel (10M2), while the closing engagement roller (101r) applies no or less pressure to the closing belt (11c).

4. The device as claimed in claim 2, in which the driving shaft (10M) is configured to be moved to vary a first distance separating it from the closing shaft (11) between a first engagement distance (L11) and a first disengagement distance (L10), and simultaneously to vary a second distance separating it from the axle shaft (12) between a second disengagement distance (L20) and a second engagement distance (L21), respectively, thus enabling
either turning of only the axle wheel (12r) and the axle shaft (12), in order to move the drum (2t) in the opening sense (Do), with the first disengagement distance (L10) and the second engagement distance (L21),
or turning of only the closing wheel (11r) and the closing shaft (11), in order to move the drum (2t) in the closing sense (Dc), with the first engagement distance (L11) and the second disengagement distance (L20),
by moving the driving shaft (10M) so as to modify the distances (L10, L11, L20, L21) separating it from the axle shaft (12) and the closing shaft (11).

5. The device as claimed in claim 2, in which the driving shaft (10M), the closing shaft (11) and the axle shaft (12) are at fixed positions relative to one another and separated from one another so that the closing and axle belts (11c, 12c) are both relaxed, and in which an engagement roller (13r) is connected to a shaft parallel to the driving shaft (10M), the closing shaft (11) and the axle shaft (12), the shaft being movable between
a first engagement position in which the engagement roller (13r) presses on the closing belt (11c) to tension it between the first driving wheel (10M1) and the closing wheel (11r) thereby defining the state engaged with the closing shaft (11), and
a second engagement position in which the engagement roller (13r) presses on the axle belt (12c) to tension it between the second driving wheel (10M2) and the axle wheel (12r) thereby defining the state engaged with the axle shaft (12).

6. The device as claimed in claim 1, in which the clutch system comprises
a closing wheel (11r) configured to turn with the closing shaft (11),
an axle wheel (12r) configured to turn with the axle shaft (12),
a drive system (10r) comprising first and second driving wheels (10M1, 10M2) mounted coaxially and rigidly on the driving shaft (10M) and configured to turn with the driving shaft (10M),
in which the driving shaft (10M) is configured to be moved between
a closing position in which the first driving wheel (10M1) is in rubbing contact with the closing wheel (11r) defining the state engaged with the closing shaft (11), and
an axle position in which the second driving wheel (10M2) is in rubbing contact with the axle wheel (12r) defining the state engaged with the axle shaft (12).

7. The device as claimed in claim 1, in which the clutch system comprises
a closing wheel (11r) configured to turn with the closing shaft (11),
an axle wheel (12r) configured to turn with the axle shaft (12),
a drive system (10r) comprising first and second driving wheels (10M1, 10M2) mounted coaxially and rigidly on the driving shaft (10M) and configured to turn with the driving shaft (10M),
in which the driving shaft (10M), the closing shaft (11) and the axle shaft (12) are at fixed positions relative to one another and separated from one another so that the first and second driving wheels (10r), the closing wheel (11r) and the axle wheel (12r) do not touch and in which the device further comprises an engagement roller (13r) connected to a shaft parallel to the driving shaft (10M), the closing shaft (11) and the axle shaft (12), the shaft being movable between
a position in contact with the closing wheel in which the engagement roller (13r) is in rubbing contact with the first driving wheel (10M1) and the closing wheel (11r) thereby defining the state of engagement with the closing shaft (11), and
a position in contact with the axle in which the engagement roller (13r) is in rubbing contact with the second driving wheel (10M2) and the axle wheel (12r) thereby defining the state of engagement with the axle shaft (12).

8. The device as claimed in claim 6, in which the first and second driving wheels (10M1, 10M2), the closing wheel (11r) and the axle wheel (12r) are toothed wheels or have adherent enabling transmission of rotation from one wheel to the other without slipping when they are in rubbing contact.

9. The device as claimed in claim 1, in which the clutch system is configured to brake in controlled manner the free rotation
of the closing shaft (11) when the clutch system is in the state engaged with the axle shaft (12), and
of the axle shaft (12) when the clutch system is in the state engaged with the closing shaft (11).

10. The device as claimed in claim 1, in which the groove in each rail is partly closed by a flange (6a) and in which
the device comprises at each rail (6) a locking belt (1c, 7c) which is fixed to each end of the rail (6), housed in the groove between each end and the corresponding chassis (23), and exits the groove at the level of the corresponding chassis by the action of idler pulleys (1r, 7r), in which
the idler pulleys (1r, 7r) are configured to insert the locking belt (1c, 7c) in the groove downstream of the insertion system (26) in order to wedge the bead (9j) under the flange (6a) leaving only an open space in the opening (14) that is insufficient to allow the bead to exit the groove via the opening (14), wherein the term downstream is defined relative to the closing sense (Dc).

11. The device as claimed in claim 10, in which the locking belts (7c) are formed by the closing cords (1c), which wrap without slipping the corresponding closing wheels (11r).

12. The device as claimed in claim 1, in which the opening (14) of each rail gives access to a space (14e) in the rail with dimensions along the transverse axis greater than that of the opening (14), and in which
in cross section normal to the longitudinal axis (X) the opening (14) of the groove has a maximum width (Lo) and the space (14e) has a maximum width (Le) greater than the maximum width (Lo) of the opening (14) (Lo<Le), where the maximum widths (Lo, Le) are measured parallel to the transverse axis (Y), and wherein
in a section normal to each longitudinal edge of the cover the corresponding bead (9j) defines an elongate geometry defined by a ratio (D/d) of a first diameter (D) to a second diameter (d) greater than unity (i.e. D/d>1) in which the first diameter (D) is defined as the length of the straight line linking the two points the farthest apart from one another of the perimeter of the geometry and the second diameter (d) is the length of the longest straight line perpendicular to the first diameter (D) that connects two points of the perimeter, and in which
the insertion system is configured to orient the bead (9j) across the opening (14) in the corresponding rail by having a diameter between d and D and less than Lo, the bead (9j) changing orientation once the bead is located in the space (14e) so that once inserted in the space (14e), the bead (9j) alone occupying the space (14e) cannot escape from it only because of the action of a force (F) applied parallel to the transverse axis (Y) in the direction of the surface (3) to be covered.

13. The device as claimed in claim 1, in which,
either the second chassis (23) comprises no motor (M) and the closing shaft (11) of the first chassis extends parallel to the transverse axis (Y) as far as the closing spool (1b) of the second chassis (23) so that the rotation of the closing spool (1b) of the first chassis (23) drives the synchronous rotation of the closing spool (1b) of the second chassis,
or the second chassis (23) comprises a single second motor (M) configured to cause the driving shaft (10M) to turn and wherein the device comprises a clutch system identical to that of the first chassis, configured so that the second motor (M) drives the rotation of only one of the closing shaft (11) and the axle shaft (12) at a time.

14. The device as claimed in claim 1, in which the motor (M) or the crank turns the same way in the opening sense (Do) and the closing sense (Dc).

15. The use of a device as claimed in claim 1 to cover a surface (3) selected from:
(a) a pool filled with a liquid or empty, the pool being chosen from a swimming pool, jacuzzi, retention pool, water treatment or water desalination pool, a sports ground, such as a tennis court or cricket pitch;
(b) a vehicle body,
(c) a glazed surface such as a greenhouse, a winter garden or a vehicle window.

16. The device as claimed in claim 1, in which the insertion system (2r, 26) coupled rigidly to the chassis.

17. The device as claimed in claim 3, in which the closing engagement roller (101r) is moved by rotation of the structure.

18. The device as claimed in claim 3, in which the axle engagement roller (102r) is moved by rotation of the structure.

19. The device as claimed in claim 9, in which the clutch system is configured for braking in controlled manner the free rotation of the closing shaft (11) and the axle shaft (12) in one of the following manners,
a braking element configured to apply a friction force to the closing shaft or the closing wheel (11, 11r) or the axle shaft or the axle wheel (12, 12r) that is not driven in rotation by the drive system (10r), applying a friction force only to the shaft or the wheel (11, 11r, 12, 12r) that is not driven in rotation by the drive system (10r), or
the closing belt (11c) or the axle belt (12c) that is relaxed applies a friction force to the corresponding closing wheel (11r) or axle wheel (12r) that it surrounds, sufficient to brake the free rotation of the corresponding shaft.

20. The device as claimed in claim 19, in which the in which the
braking element is mobile according to the state of engagement of the clutch system, applying a friction force only to the shaft or the wheel (11, 11r, 12, 12r) that is not driven in rotation by the drive system (10r).
